(19) United States
(12) Patent Application Publication
(10) Pub. No.: US 2006/0062926 A1
(43) Pub. Date: Mar. 23, 2006

(54) Use of sub-micron copper salt particles in wood preservation

(76) Inventors: H. Wayne Richardson, Sumter, SC (US); Robert L. Hodge, Sumter, SC (US)

Correspondence Address: MORGAN LEWIS & BOCKIUS LLP, 1111 PENNSYLVANIA AVENUE NW, WASHINGTON, DC, 20004, US

(21) Appl. No.: 11/009,042

(22) Filed: Dec. 13, 2004

Related U.S. Application Data
(60) Provisional application No. 60/571,535, filed on May 17, 2004.

(51) Int. Cl. B05D 1/18

(52) U.S. Cl. 427/440

(57) ABSTRACT

A method for preserving wood by injecting into the wood a slurry having: particles of a sparingly soluble copper salt, copper hydroxide, or both, wherein the weight average diameter d₅₀ of the particles in the slurry is between 0.1 microns and 0.7 microns and the d₉₈ of the particles in the slurry is less than about 1 micron; a dispersant; and water. The dispersant is anionic or a mix of anionic and non-ionic. Advantageously, less than 20% by weight of the particles have a diameter less than 20 nanometers. Useful copper salts include basic copper carbonate, tri-basic copper sulfate, copper oxychloride, basic copper nitrate, basic copper borate, copper borate, basic copper phosphate, or copper silicate. The slurry most preferably includes copper hydroxide particles. The slurry further advantageously includes at least one organic biocide, wherein at least a portion of the organic biocide is coated on the particles.

### RELATED APPLICATIONS

This application claims priority to U.S. Provisional application 60/571,535 filed on May 17, 2004, and to U.S. application Ser. No. 10/868,938 filed on Jun. 17, 2004, each of which is incorporated herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### SEQUENCE LISTING

Not Applicable

### FIELD OF THE INVENTION

The present invention relates to wood preservatives, particularly wood preservatives comprising particles of sparingly soluble copper hydroxide, or alternately a sparingly soluble basic copper salt, as well as methods to prepare the wood preservative, and methods of preserving wood using the wood

### BACKGROUND OF THE INVENTION

Preservatives are used to treat wood to resist insect attack and decay. The commercially used preservatives are separated into three basic categories, based primarily on the mode of application, into waterborne, creosote, and oil borne preservatives. Waterborne preservatives include chromated copper arsenate (CCA), ammoniacal copper quat, ammoniacal copper zinc arsenate, and ammoniacal copper arsenate. Wood treated with these chemicals sometimes turn green or grey-green because of a chemical reaction between copper in the preservative and the sun's ultraviolet rays. The preservatives leach into the soil over time, but the copper amines leach from wood at rates several times those observed for CCA.

The primary preserved wood product has historically been southern pine lumber treated with chromated copper arsenate (CCA). Most of this treated lumber was used for decks, fencing and landscape timbers. There has recently been raised concerns about the safety and health effects of CCA as a wood preservative, primarily relating to the arsenic content but also to the chromium content. In 2003/2004, due in part to regulatory guidelines and to concerns about safety, there has been a substantial cessation of use of CCA-treated products. A new generation of copper containing wood preservatives use a form of copper that is soluble. Known preservatives include copper alkanolamine complexes, copper polyaspartic acid complex, alkaline copper quaternary, copper azole, copper boron azole, copper bis(dimethyldithiocarbamate), ammoniacal copper citrate, copper citrate, and the copper ethanolamine carbonate. In practice the principal criteria for commercial acceptance, assuming treatment efficacy, is cost. Of the many copper-amine compositions listed above, only the copper ethanolamine carbonate and ammoniacal copper are in widespread use. There are several problems with these new copper-amine-containing preservatives.

The soluble copper containing wood preservatives are very leachable, compared to CCA. This leaching is of concern for at least two reasons: 1) removal of the copper portion of the pesticide from the wood by leaching will compromise the long term efficacy of the formulation, and 2) the leached copper causes concern that the environment will be contaminated. Copper is extremely toxic to certain fish at sub-part per million levels. One study reported the Synthetic Precipitation Leaching Procedure gave the leachate from CCA-treated wood contained a baseline concentration of about 4 mg copper per liter; leachate from copper (ammonium) boron azole-treated wood contained seven times the baseline; leachate from copper bis(dimethyldithiocarbamate) treated wood had twice the baseline concentration; leachate from alkaline copper quaternary treated wood had over seven times the baseline concentration; and leachate from copper citrate treated wood had over fifteen times the baseline concentration. Copper leaching is such a problem that some states do not allow use of wood treated with the soluble copper containing wood preservatives near waterways.

The commercial soluble copper containing wood preservatives cause increased metal corrosion, for example of nails within the wood. Preserved wood products are often used in load-bearing out-door structures such as decks. Traditional fastening material, including aluminum and standard galvanized fittings, are not suitable for use with wood treated with these new preservatives. Many regions are now specifying that hardware, e.g., fittings, nails, screws, and fasteners, be either galvanized with 1.85 ounces zinc per square foot (a G-185 coating) or require Type 304 stainless steel.

Further, the copper-containing portion of the treatment is not protective against some biological species, and these soluble copper containing wood preservatives require higher copper loading, a second organic biocide, or both to be effective. It is known that, unlike CCA, all of these soluble copper containing wood preservatives require a second organic biocide to be effective against some biological species. Therefore, wood preserved with these soluble copper containing wood preservatives also contain a second biocide, typically an organic biocide, that is efficacious against one or more particularly troublesome species.

Modern organic biocides are considered to be relatively environmentally benign and not expected to pose the problems associated with CCA-treated lumber. Typical organic biocides used in wood may be composed of a triazole group or a quaternary amine group or a nitroso-amine group. Biocides such as tebuconazole are quite soluble in common organic solvents while others such as chlorothalonil possess only low solubility. The solubility of organic biocides affects the markets for which the biocide-treated wood products are appropriate. Biocides with good solubility can be dissolved at high concentrations in a small amount of organic solvents, and that solution can be dispersed in water with appropriate emulsifiers to produce an aqueous emulsion. The emulsion can be used in conventional pressure treatments for lumber and wood treated in such a manner can be used in products such as decking where the treated wood will come into contact with humans.

Another concern with soluble copper preservative products generally is that most preservative materials are manufactured at one of several central locations but are used in disparate areas and must be shipped, sometimes substantial distances. The cost of providing and transporting the liquid carrier for these soluble products can be considerable, and the likelihood of an extreme biological impact on fish is very high if transported soluble copper wood preservative material is spilled or accidentally released near a waterway.

We believe the amines and/or ammonia in the current soluble copper wood treatments are responsible for increased mold, e.g., sapstain mold, as the ammonia and/or amines provide bio-available nitrogen. The amines may also promote corrosion. Also, the cost of the amine—between three and 4 moles of amine are required to solubilize a mole of copper) is very high.

U.S. Pat. No. 6,521,288 describes adding certain organic biocides to polymeric nanoparticles (particles), and claim benefits including: 1) protecting the biocides during processing, 2) having an ability to incorporate water-insoluble biocides, 3) that since the polymer component acts as a diluent a more even distribution of the biocide is achieved than the prior art method of incorporating small particles of the biocide into the wood, and finally that leaching is reduced with nanoparticles, and the biocide will be protected within the polymer from environmental degradation. The application states that the method is useful for biocides including chlorinated hydrocarbons, organometallics, halogen-releasing compounds, metallic salts, organic sulfur compounds, compounds and phenolics, and preferred embodiments include copper naphthenate, zinc naphthenate, quaternary ammonium salts, pentachlorophenol, tebuconazole, chlorothalonil, chlorpyrifos, isothiazolones, propiconazole, other triazoles, pyrethroids, and other insecticides, imidichloprid, oxine copper and the like, and also nanoparticles with variable release rates that incorporate inorganic preservatives as boric acid, sodium borate salts, zinc borate, copper salts and zinc salts. The only examples used the organic biocides tebuconazole and chlorothalonil incorporated in polymeric nanoparticles. There is no enabling disclosure relating to any metal salts. While data was presented showing efficacy of tebuconazole/polymeric nanoparticle formulations and chlorothalonil/polymeric nanoparticle formulations in wood, the efficacy of these treatments was not compared to those found when using other methods of injecting the same biocide loading into wood. Efficacy/leach resistance data was presented on wood product material, where it was found that the nanoparticle/biocide treated wood had the same properties as the wood product treated with a solution of the biocide, i.e., the polymeric nanoparticles had no effect. Finally, it is known in the art that transport of preservative material is a large cost item, and diluents will merely exacerbate this problem.

We have discussed the problems with current systems, e.g.: they add undesired oil; they increase corrosion; they are dilute; they are expensive, especially when the metal-based biocides must be combined with large quantities of organic biocides; the high copper leach rates are both a serious environmental problem in itself and it will almost certainly decrease the longevity of treatment below that obtained with CCA. However, cost is a primary factor in the selection of a wood preservative. The market is accustomed to the low cost and effectiveness of CCA, and the market is not ready to bear the incremental costs of large amounts of expensive biocides and other materials such as polymeric nanoparticles.

U.S. Patent Application 2003/0077219, which claims priority to German Patent Application No. 10148145.4 filed Sep. 28, 2001, teaches injecting very small particles of copper hydroxide (or copper oxide) into wood. In contrast to those who over-estimated the size a particle could be and still remain injectable into wood, this patent application taught using a slurry having a particle size of less than 50 nm, preferably 5 to 20 nm. This patent application also teaches a method of forming this slurry, whereby a soluble copper salt in water and one additional water-soluble reactant such as hydroxide are each formed into micro-emulsions while employing at least one block polymer to obtain intermediate products where oil or solvent is the continuous phase. The micro-emulsions are then admixed one with the other, and the particles are formed when a droplet containing a copper salt joins a droplet comprising a strong base. Such a manufacturing process can substantially reduce the normal particle size distribution of the resulting precipitate. This application teaches the copper compounds that have been produced pursuant to the described method can penetrate more easily and more deeply into the wood due to their quasi atomic size, where injection is so easy the manufacturer can eliminate or reduce the need for pressure impregnation. During the immersion of wood into the copper hydroxide micro-emulsion prepared pursuant to the invention, the copper hydroxide penetrated to a depth of more than 298 mm. Agglomerates were found in the treated wood, characterized by a size of about 100 to 300 nanometers consist of a multitude of primary particles characterized by a size range of 5 to 20 nm. This application also teaches that the copper hydroxide can be adjusted to specific applications through the appropriate doping of foreign ions. They stated that doping 5 wt % zinc into a copper hydroxide intended for agricultural applications provided enhanced surface adhesion. Doping the copper salts prepared with 5 wt % phosphate provides a surface blocking effect. There are several characteristics of this product which are unsatisfactory. First, the method of manufacturing these very small particles, emulsion precipitation, is too expensive to manufacture product to be used as a wood preservative. Second, the particles formed agglomerations which: can reduce injectability if agglomeration starts prior to injection, reduced uniform distribution of material in the wood because an agglomeration can be any size and can strip particles from injected slurry passing inward. Finally, un-agglomerated particles in the wood would be rapidly dissolved (as they are of a size wherein a complete particle is readily dissolved by water in a wood vessel) and/or flushed from the wood. Finally, while particles smaller than 0.5 microns (μm) do not tend to contribute to visible color, agglomerations, because they are spread across a surface, can contribute undesired coloring even though the total copper salt or hydroxide present in the agglomeration is less than would be obtained by a single particle of 0.25 micron diameter.

### SUMMARY OF THE INVENTION

The principal aspect of the invention is an injectable sparingly soluble copper hydroxide-containing particle preservative for wood and wood products. Preferably, the sparingly soluble copper material is sufficiently insoluble so as to not be easily removed by leaching but are sufficiently soluble to exhibit toxicity to primary organisms primarily responsible for the decay of the wood.

A first preferred embodiment of the invention is a method for preserving wood comprising the steps of: A) providing a slurry comprising: i.) particles comprising a sparingly soluble copper salt, copper hydroxide, or both, wherein the weight average diameter d₅₀ of the particles in the slurry is between 0.1 microns and 0.7 microns and the d₉₈ of the particles in the slurry is less than about 1 micron, ii.) an effective amount of a dispersant, and iii.) a liquid carrier; and B) injecting the slurry into wood. A second preferred embodiment of the invention is a method for preserving wood comprising the steps of: A) providing a slurry comprising: i.) particles comprising a sparingly soluble copper salt, copper hydroxide, or both, wherein at least 80% by weight of the particles has a diameter less than about 1 micron and at least about 50% by weight of the particles has a diameter greater than about 0.1 microns, ii.) an effective amount of a dispersant, and iii.) a liquid carrier; and B) injecting the slurry into wood. A third preferred embodiment of the invention is a method for preserving wood comprising the steps of: A) providing a slurry comprising: i.) copper hydroxide particles, wherein the weight average diameter (d₅₀) of the particles is between about 0.15 microns and about 0.17 microns, ii.) an effective amount of a dispersant, and iii.) water; and B) injecting the slurry into wood.

The dispersant advantageously comprises a anionic dispersant or a anionic dispersant and a non-ionic dispersant. Advantageously, less than 20% by weight of the sparingly soluble copper salt particles, copper hydroxide particles, or both, in the slurry is contained in particles having a diameter less than 20 nanometers. The slurry may further comprise soluble complexes of copper with an amine. A preferred sparingly soluble copper salt is basic copper carbonate. Other useful sparingly soluble copper salts include tri-basic copper sulfate, copper oxychloride, basic copper nitrate, basic copper borate, copper borate, basic copper phosphate, copper silicate, or mixtures and/or combinations thereof. The slurry most preferably comprises copper hydroxide particles. The slurry further advantageously comprises at least one organic biocide, wherein at least a portion of the organic biocide is coated on the particles. Preferably, at least a portion of the particles comprise an organic coating and an organic biocide disposed thereon. A preferred slurry has the d₅₀ of the copper-containing particles in the slurry between about 0.15 microns and about 0.25 microns. Advantageously, the providing of the particles comprises wet milling particles comprising sparingly soluble copper salt particles, copper hydroxide particles, or both with a milling medium having a density equal to or greater than about 3.8 grams/cm³ and a diameter between about 0.3 mm and about 1.5 mm. The wet milling is advantageously performed in the presence of a dispersing agent. alternately or additionally, the providing further comprises the step of partially dissolving the particles by contacting the particles with a sufficient amount of an amine and anionic surface agents such that at least 5% by weight of the copper material is dissolved. Advantageously, the sparingly soluble copper salts and/or copper hydroxide comprise less than 100 ppm, preferably less than 40 ppm lead based on the weight of the particles. Advantageously, the slurry further comprises hydroxyethylidene diphosphonic acid. In any case, the providing may comprise admixing a dry mix comprising the particles and a dispersing agent with water, wherein advantageously the dry mix further comprises a granulating agent that is dispersible in water. Alternately, the providing may comprise admixing a slurry concentrate or wet-cake comprising dispersants with water.

The preferred sparingly soluble copper material is copper(II) hydroxide, with formula Cu(OH)₂. In another embodiment, the particles comprise substantially crystalline copper(II) hydroxide. In another embodiment, the particles comprise stabilized copper(II) hydroxide. There is a tendency for copper hydroxide to lose water and thereby form copper oxide. Copper oxide has a lower activity than does copper hydroxide—copper(II) oxide has too little activity to be useful in many environments, and copper(I) oxide has low activity (compared to copper hydroxide). This problem is exacerbated when the copper hydroxide is in very small particles. This problem is also exacerbated when the copper hydroxide is exposed to heat and drying conditions, such as would be experienced during kiln drying of treated wood. The preferred compositions comprise a stabilized form of copper hydroxide that is resistant to the transformation to copper oxide. Such copper hydroxide may comprise one or more of zinc and/or magnesium substituted (in a minor amount) in place of copper ions in the copper hydroxide, wherein these cations are either dispersed within the sparingly soluble copper composition or be a separate phase within a particle. One preferred method of making copper hydroxide particles is a variation of the method taught by U.S. Pat. No. 3,231,464, the disclosure of which is incorporated herein by reference thereto, wherein the presence of magnesium or magnesium and zinc can help stabilize cupric hydroxide from converting to copper oxide via the loss of a water molecule. In preferred embodiments of the invention, at least some particles comprise copper hydroxide, basic copper carbonate, or both, having magnesium ions therein. Alternately, the copper hydroxide particle may comprise a minor amount of phosphate, wherein the phosphate is present in an amount sufficient to at least partially prevent or retard the conversion of copper hydroxide to copper oxides. Generally, between 0.2% and 5% by weight of phosphate is sufficient.

Other useful copper-containing materials consist of sparingly soluble basic copper salts, which can be envisioned as comprising a mixture (at a certain ratio) of a copper salt such as copper sulfate, copper carbonate, or the like, with copper hydroxide.

A critical aspect of the invention is the particle size and morphology. Generally, the injectable particles will be in the form of a slurry having a wide range of particle sizes. When not specified, the particle size is the d₅₀, which is the particle diameter (determined by settling velocity and Stokes Law) where 50% by weight of the material, e.g., sparingly soluble copper salts, preferably sparingly soluble basic copper salts, and most preferably copper(II) hydroxide, exist as particles having a diameter equal to or less than the d₅₀, and just less than 50% by weight of the material exist as particles having a diameter greater than the d₅₀. It is recognized that particles are almost always present in a variety of sizes, which typically form a distribution which can resemble a normal distribution curve. The slurry will therefore typically contain some particles having a diameter of three to five times the d₅₀, and some particles having a diameter of one third to one fifth times the d₅₀. If an appreciable fraction of the particles are too large, the slurry will not provide commercially acceptable product, because material will be plated on the surface and/or complete uniform penetration will not be achieved. If particles are too small, then stabilization against conversion to copper oxide will not be effective, particles will tend to dissolve too fast, and/or particles may be flushed from wood by fluid flowing there-through.

Generally, the particle size distribution in the slurry being injected into wood should have a d₁₀₀ of a slurry (the particle diameter wherein 100% by weight of the material in the slurry has a particle diameter equal to or less than the d₁₀₀), or alternately a d₉₈, equal to or less than 1 micron. In preferred embodiments of this invention, the d₁₀₀, or alternately the d₉₈, of the slurry is equal to or less than about 0.7 microns. More preferably, the d₁₀₀, or alternately the d₉₈, of the copper-containing particles in a slurry is 0.5 microns or less. In one embodiment, exemplary wood preservative slurries comprise sparingly soluble copper salt-containing particles having a size distribution in which the d₉₈ is about 0.25 μm, or alternately about 0.2 μm.

In one embodiment of the invention the material has less than 20% by weight of particles having a diameter less than about 0.02 microns, i.e., the d₂₀ is greater than 0.02 microns. In a preferred embodiment of this invention, the d₂₀ is at least 0.04 microns. In more preferred embodiments, the d₂₀ is 0.05 microns or greater.

In one embodiment, exemplary wood preservatives comprise copper-based particles having a size distribution in which the d₅₀ is about 0.25 μm, alternately about 0.2 μm, or in other embodiments about 0.15 μm. In preferred embodiments, the d₅₀ is 0.1 microns or greater. Therefore, the preferred slurries for injection into wood have sparingly soluble copper salts with a particle size between about 0.05 and 0.5 microns. Alternately, in one preferred embodiment, at least 80% by weight of the copper-containing particles have a size between 0.05 microns and 0.4 microns. For a slurry with a normal distribution of particle sizes, the d₅₀ will therefore be between about 0.1 and about 0.2 microns, or alternately between about 0.15 and about 0.25 microns. A preferred wood preservative is a slurry comprising copper hydroxide, wherein the copper hydroxide particles have a d₅₀ of about 0.17 (plus or minus 0.05) microns.

The absence of particles having a diameter greater than 1 micron also means the slurries are stable—slurry particles settle over the course of over a day, so there is little danger of a slurry settling prior to injection. Generally, it is preferred that less than 1% of solids settle in 3 hours time.

We have identified methods to reduce the particle size of the sparingly soluble copper salts or hydroxide. A first method involves partially dissolving a slurry by admixing some amine that will form a soluble complex with copper and/or a complexing acid such as polyacrylate to a slurry or slurry concentrate having particles of a size greater than desired. The components can be admixed with high sheer. The amines, which can include ammonia, monoethanolamine, diethanolamine, ethylene diamine, or the like, partially dissolve the particles by forming stable soluble complexes with copper. In addition to dissolving some material, at least a portion of the polyacrylate, poly(meth)acrylate or other polymer having a plurality of acidic monomers, will act as a dispersing agent. Generally, the amount of polyacrylate and amine added to a slurry or slurry concentrate should be effective to dissolve between 5% and 30% by weight of the particles present. By partially dissolving particles, the particle diameter is decreased. The polyacrylate or other dispersants will help stabilize the smaller particles. Mixing the copper-containing particles with high sheer and in the presence of polyacrylates will also reduce by attrition large particles, e.g., particles having a diameter of over 1 micron. The remaining particles can be separated from the fluid having the copper-amine complex and/or soluble copper complexed with soluble acidic polymers, or this fluid having the copper-amine complex and/or soluble copper complexed with soluble acidic polymers can form a part of the resultant slurry for injection into wood.

We have also found that wet milling with milling material such as 1 mm or less of zirconium silicate and/or zirconium oxide will reduce by attrition particles over about 1 micron in size. Generally, milling is more efficient if at least a portion of the milling material has a size equal to or less than 1 mm, and/or if a portion of the milling material has a density equal to or greater than that of zirconium silicate. Preferred milling material is sub-millimeter zirconium oxide, which may be stabilized, doped, or otherwise treated. Advantageously, dispersants or other surface active agents are present during the wet milling process.

Other aspects of this invention include 1) methods to manufacture the sub-micron particles; 2) methods of formulating the compositions that comprise the particles for use in wood preservation, including compositions that are concentrates used to ship and store the copper-containing particles, as well as diluted slurries adapted to be injected into wood; 3) methods of injecting the copper-containing particles; and 4) wood and wood products treated with the particle preservative treatment compositions.

The copper-containing particles are formulated into a stable slurry, which is then injected into wood using pressures, practices, and times normally used for soluble copper amine preservative systems. We believe the combination of methods to manufacture injectable particles having desirable efficacy into wood, as well as our formulations, represent a significant discovery. Simple changes in the treatment regimen, including a more ramped increase in pressure and/or using sufficiently diluted slurries will also help minimize bridging and plugging of pore throats, with accompanying undesirable deposition of material on the surface of wood.

It is believed that certain organic biocides are normally long-lasting and very effective against most (but not all) undesired bio-organisms, but are ineffective against and may be subjected to degradation by a few bio-organisms. A principal function of the copper in such a system may be to inhibit growth of those bio-organisms that degrade the organic biocides and/or that are resistant to the organic biocides. The most preferred embodiments of this invention have copper hydroxide, or less preferably a sparingly soluble basic copper salt, as particles, and further comprise between about 0.01% to about 20% by weight of one or more organic biocides, based on the weight of the copper-containing particles.

In some embodiments, the organic material is present as a separate emulsion added to the slurry of copper hydroxide particles. In other embodiments, the particles form a carrier to carry the organic biocides into the wood and help ensure the biocide is well-distributed throughout the wood. Preferred embodiments of the invention are injectable copper-containing biocidal particles that further comprises one or more organic biocides attached to the surface of the copper hydroxide and/or basic copper salt particles.

The costs per pound of copper-containing particles is estimated to be 30% to 50% lower than present copper-MEA-carbonate preservatives. Corrosivity of the product is expected to be less than that associated with the copper-amine preservatives. Freight should be only one third that associated with the copper-amine preservatives.

### LIST OF FIGURES

Various aspects of the invention are illustrated by the following figures:

FIG. 1 are photographs showing the penetration of injected particle copper hydroxide developed with dithio-oxamide in the third picture, where the stain corresponds to copper, showing the copper-containing particles are evenly dispersed throughout the wood;

FIG. 2 is a graph showing leaching data for the wood samples injected with the various particle slurries (and also of the leaching data from two controls);

FIG. 3 are photographs (best seen in color) of wood samples after trying to inject copper carbonate having a d₅₀ of 2.5 microns (on the left), and of wood samples after injecting a milled slurry having a d₅₀ between 0.15 and 0.2 microns on the right; and

FIG. 4 shows the approximate particle size distribution of the a sample of Champ DP TM copper hydroxide particles such as was successfully injected into wood.

### DESCRIPTION OF EMBODIMENTS

The principal aspect of the invention is an injectable sparingly soluble copper hydroxide-containing particle preservative for wood and wood products. Preferably, the sparingly soluble copper material is sufficiently insoluble so as to not be easily removed by leaching but are sufficiently soluble to exhibit toxicity to primary organisms primarily responsible for the decay of the wood. A “sparingly soluble” material (or salt) as used herein has a Ksp in pure water between about 10⁻⁸ to about 10⁻²⁴ for salts with only one anion, and from about 10⁻¹² to about 10-27 for salts with two anions. Preferred sparingly soluble salts have a Kₛₚ between about 10⁻¹⁰ to about 10-21. As used herein, preferred sparingly soluble inorganic salts includes salts with a Kₛₚ of between about 10⁻¹² to about 10-24 for salts with only one anion, and from about 10⁻¹⁴ to about 10-27 for salts with two anions.

By “injectable” we mean the wood preservative particles are able to be pressure-injected into wood, wood products, and the like to depths normally required in the industry, providing an effective dispersion of biocidal particles throughout the injected volume, using equipment, pressures, exposure times, and procedures that are the same or that are substantially similar to those currently used in industry. Pressure treatment is a process performed in a closed cylinder that is pressurized, forcing the chemicals into the wood. Copper loading, also called copper retention is a measure of the amount of preservative that remains in the wood after the pressure is released; It is given as “pcf,” or pounds of preservative per cubic foot of wood. Retention levels that must be reached are dependent on three variables: the type of wood used, the type of preservative used, and the use of the wood after treatment. The sparingly soluble copper-salt particles of this invention are typically expected to be added to wood in an amount equal to or less than 0.25 pounds as copper per cubic foot, more typically between about 0.05 and 0.1 pounds copper per cubic foot. In preferred embodiments of the invention incising is not expected to be required to inject the slurries of the present invention into lumber having thickness of 4 inches.

Injectability requires the particles be substantially free of the size and morphology that will tend to accumulate and form a filter cake, generally on or near the surface of the wood, that results in undesirable accumulations on wood in one or more outer portions of the wood and a deficiency in an inner portion of the wood. Injectability is generally a function of the wood itself, as well as the particle size, particle morphology, particle concentration, and the particle size distribution.

Unless otherwise specified, all compositions are given in “percent”, where the percent is the percent by weight based on the total weight of the entire component, e.g., of the particle, or to the injectable composition. In the event a composition is defined in “parts” of various components, this is parts by weight wherein the total number of parts in the composition is between 90 and 110.

SPARINGLY SOLUBLE COPPER SALTS AND/OR HYDROXIDE: Preferred inorganic copper salts include copper hydroxides; copper carbonates; basic (or “alkaline”) copper carbonate; basic copper sulfate including particularly tri-basic copper sulfate; basic copper nitrates; copper oxychloride (basic copper chloride); copper borate; basic copper borate; copper silicate; basic copper phosphate; and mixtures thereof. The particulate copper salts can have a substantial amount of one or more of magnesium, zinc, or both, e.g., between about 6 and about 20 parts of magnesium per 100 parts of copper, for example between about 9 and about 15 parts of magnesium per 100 parts of copper, wherein these cations are either dispersed within, or constitute a separate phase within, a particulate. The preferred sparingly soluble copper material is copper(II) hydroxide, with formula Cu(OH)₂. In another embodiment, the particles comprise substantially crystalline copper(II) hydroxide. In another embodiment, the particles comprise stabilized copper(II) hydroxide, i.e., a stabilized form of copper hydroxide that is resistant to the transformation to copper oxide. Such copper hydroxide may comprise one or more of zinc and/or magnesium substituted (in a minor amount) in place of copper ions in the copper hydroxide, wherein these cations are either dispersed within the sparingly soluble copper composition or be a separate phase within a particle. In a preferred embodiment of the invention, at least some particles comprise copper hydroxide, basic copper carbonate, or both, having magnesium ions therein. In more preferred embodiments, the copper hydroxide (or alternately basic copper carbonate) comprises between 6 and 20 parts of magnesium per 100 parts of copper, for example between 9 and 15 parts of magnesium per 100 parts of copper. Alternatively, in another more preferred embodiments, the copper hydroxide comprises between 6 and 20 parts total of magnesium and zinc per 100 parts of copper, for example between 9 and 15 parts total of magnesium and zinc per 100 parts of copper. In some embodiments, the basic copper carbonate comprises between 6 and 20 parts of magnesium per 100 parts of copper, for example between 9 and 15 parts of magnesium per 100 parts of copper, or alternatively between 6 and 20 parts total of magnesium and zinc per 100 parts of copper, for example between 9 and 15 parts total of magnesium and zinc per 100 parts of copper. Alternatively or additionally, in a preferred embodiment, the copper hydroxide and/or basic copper carbonate comprises between about 0.01 and about 5 parts of phosphate per 100 parts of copper, for example between 9 and 15 parts of phosphate per 100 parts of copper.

Alternately, the copper hydroxide particle may comprise a very minor amount of an insoluble anion, for example between 0.1 and 5% phosphate, typically between 0.3% and 3% phosphate, by weight based on the weight of the particles.

Other useful copper-containing materials consist of sparingly soluble basic copper salts, which can be described as comprising a ratio of a copper salt to copper hydroxide. The most preferred basic copper salt is basic copper carbonate. Other useful basic copper salts include basic copper sulfates including particularly tri-basic copper sulfate; basic copper nitrates; copper oxychloride (basic copper chlorides); basic copper phosphates, and basic copper borates. In another embodiment, the particles comprise a substantially crystalline sparingly soluble basic copper salt.

PARTICLE SIZE: A critical aspect of the invention is the particle size and morphology. As used herein, particle diameters may be expressed as “dₓₓ” where the “xx” is the weight percent (or alternately the volume percent) of that component having a diameter equal to or less than the dₓₓ. The d₅₀ is therefore the diameter where 50% by weight of the component is in particles having diameters equal to or lower than the d₅₀, while about 50% of the weight of the component is present in particles having a diameter greater than the d₅₀. A d₉₀ of 0.8 microns means that 90% by weight of the particles in the slurry have a diameter equal to or less than 0.8 microns, and that just under 10% by weight of all the particles in the slurry have diameters greater than 0.8 microns. Particle diameter is preferably determined by Stokes Law settling velocities of particles in a fluid, for example with a Sedigraph™ 5100T manufactured by Micromeritics, Inc., Norcross, Ga., which uses x-ray detection and bases calculations of size on Stoke's Law, to a size down to about 0.15 microns. The roundness of particles plays a role in the measured diameter, as round particles will settle faster (and therefore have a larger apparent diameter) than particles of similar weight having a rod or sheet shape. Smaller sizes (less than 0.15 microns) are preferably determined by a dynamic light scattering method, preferably with a Coulter™ counter. A preferred particle sizing technique is a sedimentation or centrifugation technique based on Stokes law, exclusive of dispersants and adjuvants.

Generally, the injectable particles will be in the form of a slurry having a wide range of particle sizes. If an appreciable fraction of the particles are too large, the slurry will not provide commercially acceptable product, because material will be plated on the surface and/or complete uniform penetration will not be achieved. If particles are too small, e.g., less than 0.02 microns, then stabilization against conversion to copper oxide will not be effective, particles will tend to dissolve too fast, and/or particles may be flushed from wood by fluid flowing there-through.

It is known that the vessels in wood can typically have a diameter of 50 microns. Therefore, it was believed in the prior art that particles with a diameter that is a fraction of 50 microns, say 25 microns or even 10 microns, would be readily injectable into wood. We believe slurries having such large particles will not be injectable into wood. We believe the critical size for injectability is that the particles be size to fit through a pit in the wood structure, not through a vessel. As the wood cell wall is forming, small openings called pits are created. Pits are thin spots where the secondary wall has not formed. Pits are normally matched in pairs between adjacent cells and allow liquids to pass freely from one cell to the next. The diameter of pits in wood structures are highly variable, and they are much smaller (due to phenomena such as encrustation) in heartwood than in sapwood. Because they are very small, in some species pits can be easily plugged by deposits in the heartwood, making the cell wall almost impermeable to liquids and therefore difficult to treat. See, e.g., Treatability and Durability of Heartwood by Wang and DeGroot, at www.fpl.fs.fed.us/documnts/pdf1996/wang96b.pdf. We believe an average effective diameter of pits is generally about 2 microns. Therefore, a slurry of particles having diameters of about 2 microns or more can obviously not be injected into many types of wood, particularly heartwood.

Just because a slurry does not contain (many) particles bigger than a pore throat does not mean the slurry can be injected through the pore throat. Generally, a slurry of round particles will not plug a pore throat (pit) if the diameter of the particles passing through the pore are less than about one third the diameter of the pore throat. This rule of thumb would suggest a slurry having particles having diameters of about 0.6 to 0.7 microns should be injectable. In the most preferred embodiments of this invention, the d₁₀₀ of a slurry (the particle diameter wherein 100% by weight of the material in the slurry has a particle diameter equal to or less than the d₁₀₀) is equal to or less than about 0.7 microns. The particles in a commercial slurry, however, may not be round. Preferred particles are substantially round, e.g., the diameter is one direction is within a factor of two of the diameter measured in a different direction, such as would be found in milled particles. As the sparingly soluble particles may not be round, and as they may comprise a volume of adjuvants that make up for example as much as 30% of a pore volume, a more conservative value would be to have the particles be one fourth to one fifth the diameter of the pit openings. This would suggest a particle diameter should be for example between 0.4 to 0.5 microns (or less) for a slurry to be readily injectable into a variety of commercial woods where an average effective pit diameter is 2 microns. More preferably, the d₁₀₀, or alternately the d₉₈, of the copper-containing particles in a slurry is 0.5 microns or less. In one embodiment, exemplary wood preservative slurries comprise sparingly soluble copper salt-containing particles having a size distribution in which the d₉₈ is about 0.4 μm.

In one embodiment of the invention the material has less than 20% by weight of particles having a diameter less than 0.02 microns, i.e., the d₂₀ is greater than 0.02 microns. In a preferred embodiment of this invention, the d₂₀ is at least 0.05 microns. In more preferred embodiments, the d₂₀ is 0.05 microns or greater.

Therefore, the preferred slurries for injection into wood have sparingly soluble copper salts with a particle size between about 0.05 and 0.5 microns. Alternately, in one preferred embodiment, at least 80% by weight of the copper-containing particles have a size between 0.05 microns and 0.4 microns. Most economical methods of manufacturing small particles will provide a slurry with a particle size distribution. The tighter the particle size distribution the better the injectability of the resulting slurry. Once a pore throat is partially plugged, complete plugging and undesired buildup generally quickly ensues. Where there is a broad particle size distribution, to make sure that two or three oversize particles do not plug a pore, the d₅₀ is usually specified to be a fraction of the maximum injectable particle size. For a slurry with a normal distribution of particle sizes, the d₅₀ will therefore be between about 0.1 and about 0.2 microns. In one embodiment, exemplary wood preservatives comprise copper-based particles having a size distribution in which the d₅₀ is between about 0.1 to 0.3 microns, e.g., about 0.25 μm, alternately about 0.2 μm, or alternately about 0.15 μm. In preferred embodiments, the d₅₀ is 0.05 microns or greater, more preferably 0.1 microns or greater.

A preferred wood preservative is a slurry comprising copper hydroxide, wherein the copper hydroxide particles have a d₅₀ of about 0.17 microns. An exemplary product is Champ DP® brand copper hydroxide (available from Phibro-Tech Inc., Fort Lee, N.J.), which is stabilized copper hydroxide having a d₅₀ of 0.17 microns. Such a product is usable but is not preferred—one sample of Champ DPOR brand copper hydroxide tested had a d₉₈ of 10 microns, a dgo of 2 microns, and a d₈₃ of 1 micron. Such a material, while generally operable, will likely leave between 10% and 20% of the total weight of copper hydroxide as a film on the surface of the wood. Such a product is operable, in that sufficient copper can be injected to provide a desired level of protection, but the level of material on the surface is not commercially desirable.

There are several ways to improve the injectability and suspendability of such a slurry. A second test was performed on Champ DP® brand copper hydroxide that was specially formulated to partially dissolve particles and to minimize particle agglomeration. The materials added are amines to solubilize copper, and anionic dispersants including particularly poly (meth)acrylate which dissolve and complex copper, and which also stabilize the particles and prevent agglomeration. Such a slurry was prepared, starting with a copper hydroxide material having a d₅₀ of 0.17 microns where between 80% and 83% of the copper hydroxide had particle sizes below 1 micron, wherein the resulting material had a d₅₀ of about 0.15 microns. More importantly the product mixture had a d₁₀₀ below 10 microns (that is, no particles were found to have a diameter equal to or greater than 10 microns), a d₉₆ of about 1 micron, and between 85% and 92% of the total weight or diameter of the particles having a diameter less than 0.5 microns, e.g., a d₅₀ of about 0.5 microns. This is a significant improvement over untreated Champ DP® brand copper hydroxide where the d₅₀ of a sample was found to be 2 microns.

We found other treatments were able to more effectively reduce the particle size distribution, especially the fraction of material in particles bigger than 1 micron. We found wet milling with a media comprising ceramic or steel balls of diameter equal to or less than about 2 mm, preferably of diameter equal to or less than 1 mm, can provide even tighter particle size distributions. A wet milled slurry will have particles that are generally rounder and more readily injectable to greater depths in the wood, and will have a lower tendency to leave material on the face of the wood, either through settling over time or through material not being injectable into the wood. Indeed, such a slurry when injected into wood will leave very little of the copper hydroxide material as a film on the surface of the wood.

Further, we subsequently unexpectedly found that a rigorous milling regimen with 0.5 millimeter milling media can provide an injectable slurry of particles regardless of the initial d₅₀ of the starting material. There appears to be a minimum size that a salt can be milled to, but 30 minutes of high speed wet milling with a composition comprising sufficient dispersants was found to make an injectable slurry, even if the starting material had a d₅₀ greater than 2 microns.

The leach rate of copper from the wood is an important property. A very low leach rate implies the copper can not readily dissolve, and therefore will not provide protection against certain species of pests. Too high a leach rate, and the treatment can be eluted from the wood in a period of time considerably less than the 20 to 30 year expected lifetime of treated wood. The sparingly soluble biocidal particles are relatively non-leachable, being comparable with the leach rates associated with the CCA products, and being much lower than the leach rates associated with soluble copper amine wood preservatives. Due to lower leach rates, the wood treated with the preservatives of this invention should be usable underground, near waterways, and also in marine applications.

Advantageously, the particles of the present invention provide at 300 hours into an AWPA E11-97 leach test a total leached copper value that is within a factor of two above, to within a factor of five below, preferably within a factor of three below, the total leached copper value obtained by a wood sample treated with CCA and subjected to the same test. The leach rate of copper from wood treated with the copper-containing particles of this invention is a factor of about six to twenty less than the leach rate of copper from wood treated with the soluble copper-amine complexes in commercial use today.

The dissolution rate/leach rate of the sparingly soluble copper salts used in the particles will be a function of 1) the solubility of the sparingly soluble copper salt(s) in the leachant; 2) the surface area of the sparingly soluble copper salts available to contact the leachant, 3) the energy of the crystal which must be overcome to dissolve ions from the crystal lattice, and 4) the flow characteristics of the leachant in the wood matrix, especially regarding boundary layer effects. Each of these properties plays a role in every flow rate scenario, but some are more dominant than others at certain times. We believe the leach rates will be primarily governed by the solubility of the sparingly soluble salts and by boundary layer effects of the copper and counter-ions diffusing from the particles in regimes where the leachant is moving extremely slowly, e.g., less than a few millimeters per day. At intermediate leachant flow rates, we believe the leach rate of copper will depend on primarily on the available surface area. At higher rates, such as found in the standard test methods typically used by industry, the leach rates will be governed more by the available surface area of the sparingly soluble salts and by the energy of the crystal lattice.

Larger size particles have lower leach rates, while particles in a size range from 1 to 20 nanometers under many circumstances will not have a leach rate much different than that of an injected and dried copper salt solution. In preferred embodiments of this invention, the d₅₀ is at least 0.05 microns, meaning at least 50% by weight of the copper-containing particles have a size greater than 50 nanometers. In more preferred embodiments, the d₅₀ is 0.1 microns or greater.

Dissolution is a function not only of the pH of the water within the wood and the solubility product value for the particular salts, but also on dynamic conditions. Since the copper is present in the wood as particles, dissolution of copper will also be restricted by the low surface area of the particles. Larger particles will reduce the leaching rate in most leachant flow regimes. The dissolution of larger particles is more dependent on surface effects than is the dissolution of smaller particles, in part because the available surface area is lower for larger particles. At low flow rates, boundary layer effects may multiply the effects of lower surface area, but at typical leach test flow regimes boundary layer effects may be minimized if the flow of the leachant through the wood matrix is turbulent.

Solubility of copper is strongly dependent on the pH, and for the hydroxide is about 0.01 ppm at pH 10, 2 ppm at pH 7, but is 640 ppm at pH 4. Wood has a “pH” between 4 and 6. At low flow rates, the pH of the leachant will be modified by the dissolution of the copper hydroxides and the copper carbonates. The iso-electric point of copper hydroxide is about 11, making copper hydroxide a very effective base. Therefore, copper hydroxides are a component of the preferred copper material, as the hydroxides will raise the pH of the water in the wood. A large particle of copper hydroxide can create a micro-environment within the wood where the solution contacting the particle has a pH that is more neutral. A vessel in wood can have a diameter of 20 to 50 microns and a length of several hundred microns, giving a volume of a vessel of between about 2 to 20*10³ microns³. A particle of diameter of 0.02 microns will have a volume of about 2*10⁻⁶ microns³, or about 1 volume of particle per billion volumes of space. A single particle having a diameter of 0.02 microns will likely be completely dissolved the first time the vessel (large hollow cells used by tree to transport water) is filled with water. A 0.2 micron particle will occupy about 1 volume per million volumes of space in a vessel. Such a particle will not be likely to completely dissolve when the vessel or vessel fills with water.

The presence of other basic salts, for example phosphate ions, can further hinder leach rates. Alkali-metal bases, such as alkali-metal hydroxides, tri-basic alkali-metal phosphates, tri-basic alkali-metal borates, and less preferred alkali-metal carbonates and alkali-metal salts of organic carboxylic and/or sulfonic acid containing material, can be included in the liquid portion of the injected slurry to increase the pH in the wood. At high leachant flow rates, however, such as are used in standard leachant tests, the flow rates are such that the presence of hydroxides, phosphates, and the like are minimized.

Leaching is not the only mechanism whereby material can be flushed from wood. Because the material is in particle form, there is a possibility that particles will be flushed from the wood. The prior art suggests that very small substantially spherical nanoparticles, i.e., spherical particles of size 5 to 20 nanometers, can migrate freely through a wood matrix. However, while said particles are easy to inject, they are also clearly easily transported through wood and would be easily flushed from the wood. These wood preservative treatments would not be long-lasting, because the small particles will have a faster dissolution rate than larger particles, and alternatively or additionally the small particles can be flushed from the wood under certain conditions.

The preferred formulation reduces and optionally eliminates the nitrogen content of the prior art products; as we believe the nitrogen is associated with the enhanced rate of sapstain growth which presently necessitates the use of expensive sapstain control agents. Advantageously, the selection of surfactants and dispersants are made to minimize the amount of amine associated with the copper. Another embodiments of the invention is an injectable particle preservative for wood that is substantially free of bio-available nitrogen, and also is substantially free of bio-available carbon. By substantially free of bio-available nitrogen we mean the treatment comprises less than 10% of nitrates and organic nitrogen, preferably less than 5% of nitrates and organic nitrogen, more preferably less than 1% of nitrates and organic nitrogen, for example less than 0.1% of nitrates and organic nitrogen, based on the weight of the copper in the wood preservative. In most of the soluble or complexed copper-amine treatments, there are between 2 and 4 atoms of organic nitrogen per atom of copper. In a preferred embodiments of this invention, there is less than 0.3 atoms, preferably less than 0.1 atoms, for example less than 0.05 atoms of organic nitrogen per atom of copper in the wood preservative treatment. Organic nitrogen-containing compounds that are used specifically as supplemental biocides are excluded from this limitation.

The slurries of this invention can be essentially unaffected by the use of hard water in the slurry. In contrast, the soluble copper-amine solutions used in the prior art, when diluted with hard water, precipitated an objectionable residue of calcium and magnesium carbonates onto the surface of the wood.

Injection of the present formulation uses the standard operating procedure that is commonly practiced in the industry. In some embodiments, the pressure is increased more gradually that the normal instantaneous step increase from about 0 psig to over 100 psig that is often seen in the field. Extending the time to increase the pressure to between about 2 and about 10 minutes will slow the rate of injection, and thereby be an additional factor in minimizing the potential for bridging and plugging pore throats.

METHOD OF MANUFACTURING A SLURRY: There is a large number of references describing how to make copper-containing “nanoparticles.” These references generally can not be used to manufacture the particles, with an end use as a Wood preservative, at a commercially acceptable cost. The most cost effective method we have found is a precipitation reaction, followed by one or more of wet milling or partial dissolution.

One method that is not cost effective is using an emulsion precipitation or emulsion crystallization technique, where small particles are allowed to grow in a certain phase of an emulsion, where the ultimate size of the particle is limited by the amount of a component in a droplet in the emulsion. Both inorganic salts and organic biocidal particles can be formed in this manner, but not at a cost where such materials would be useful for foliar applications on crops nor for wood preservation. The reaction and particle formation are relatively slow, the costs of the solvents and surfactants necessary to maintain stable emulsions are high, as is the cost of separating the solvents from the resulting particles.

Another method that is not cost effective is a fuming process, where a copper containing organic compound is degraded in a plasma comprising oxygen to form copper oxide. The cost of the chemical intermediates is very high, as is the cost of gathering the resultant oxide. Additionally, this methodology is only useful for forming metal oxides, nitrides, borides, and the like, and is not particularly useful for forming metal hydroxides or sparingly soluble basic copper salts.

In one useful embodiment of the invention, copper hydroxide particles are prepared by precipitation from a mixture comprising copper and an amine. This reaction can economically produce the desired copper salts, especially is the copper-amine composition is prepared by direct oxidation of scrap copper via the process disclosed in U.S. Pat. No. 6,646,147, the disclosure of which is incorporated by reference. The particles may be prepared by modifying a pH of the mixture comprising copper and the amine, surprisingly in a downward direction to pH 6 or with an alkali hydroxide to obtain a pH greater than about 13. A dispersant may be added to the mixture before obtaining the precipitate. In one embodiment, the pH is adjusted so that the pH is between about 5.5 to about 7. Suitable acids for adjusting the pH include, for example, sulfuric acid, nitric acid, hydrochloric acid, formic acid, boric acid, acetic acid, carbonic acid, sulfamic acid, phosphoric acid, phosphorous acid, and/or propionic acid. The anion of the acid used may be partially incorporated in the precipitated salt, as may other cations, such as magnesium and/or zinc.

U.S. Pat. No. 4,808,406, the disclosure of which is incorporated by reference, describes a useful method for producing finely divided stable cupric hydroxide composition of low bulk density comprising contacting solutions of an alkali metal carbonate or bicarbonate and a copper salt, precipitating a basic copper carbonate-basic copper sulfate to a minimum pH in the range of greater than 5 to about 6, contacting the precipitate with an alkali metal hydroxide and converting basic copper sulfate to cupric hydroxide.

Another method of manufacturing the copper compounds is the method described in U.S. Pat. No. 4,404,169, the disclosure of which is incorporated by reference. This patent describes a process of producing cupric hydroxides having stability in storage if phosphate ions are added to a suspension of copper oxychloride in an aqueous phase. The copper oxychloride is then reacted with alkali metal hydroxide or alkaline earth metal hydroxide, and the cupric hydroxide precipitated as a result of the suspension is washed and then re-suspended and subsequently stabilized by the addition of acid phosphate to adjust a pH value of 7.5 to 9. The suspended copper oxychloride is preferably reacted in the presence of phosphate ions in an amount of 1 to 4 grams per liter of the suspension and at a temperature of 20° to 25° C. and the resulting cupric hydroxide is stabilized with phosphate ions.

There are numerous methods of preparing very small particles of copper salts, and the above list is exemplary and not complete. It is important to note that the size of the precipitates is relatively unimportant, and the cost of the reagents is exceedingly important. The material need not be of high purity. Indeed, it is often desirable to have one or more “contaminants” in the precipitating solutions. Smaller diameters are obtained when the concentration of impurities such as Mg, Ca, Zn, Na, Al and Fe in the suspension is high. Fe present in the suspension acts especially strongly to prevent formation of large-diameter cuprous hydroxide particles. On the other hand, the copper should not have high concentrations of lead, for example from scrap soldered copper.

Copper hydroxide is not particularly stable. Hydroxides can be changed to oxides by for example in a quick and exothermic reaction by exposure of the copper hydroxide particles to aqueous solution of glucose. Copper hydroxide may react with air, sugars, or other compounds to partially or completely form copper oxide. The conditions for conversion are highly favored during kiln-drying treated wood, which contains gluconuuronic acids, which are sugar-like molecules, and heat and a dehydrating condition. However, as taught by U.S. Pat. No. 3,231,464, the disclosure of which is incorporated herein by reference thereto, the presence of magnesium or magnesium and zinc can help stabilize cupric hydroxide from converting to copper oxide via the loss of a water molecule. The preferred copper hydroxide particles used in this invention are stabilized. U.S. Pat. No. 3,231,464 teaches stabilizing the copper hydroxide with added magnesium zinc, or both, at a Cu:Mg and/or Cu:Zn weight ratio of 8:1. Copper hydroxide prepared in a manner so as to contain significant magnesium and/or zinc hydroxides are more stable and resistant to degradation to copper oxides. The preferred copper hydroxide particles comprise between 50% and 90 copper hydroxide, with the remainder comprising zinc hydroxide, magnesium hydroxide, or both.

In one embodiment of the invention, copper-based particles are precipitated from a mixture of a copper salt solution and a hydroxide (and optionally other anions) in the presence of at least one group 2a metal or salt thereof, such as magnesium or a magnesium salt. In one embodiment, the copper-based particles are precipitated from a mixture comprising at least about 0.05 parts magnesium, for example at least about 0.1 parts magnesium per 9 parts copper. The mixture may comprise at least about 0.25 parts magnesium per 9 parts copper. The mixture may comprise less than about 1.5 parts magnesium, for example, less than about 1.0 parts, or less than about 0.75 parts magnesium per 9 parts copper. Copper-based particles prepared in accordance with the present invention will comprise a group 2a metal or zinc if such materials (metal ions) were used in preparation of the particles. In another embodiment, the copper-based particles are precipitated from a mixture comprising at least about 0.2 parts magnesium, for example at least about 0.25 parts magnesium per 22.5 parts copper. The mixture may comprise at least about 0.5 parts magnesium per 22.5 parts copper. The mixture may comprise less than about 3.5 parts magnesium, for example, less than about 2.5 parts magnesium, or less than about 2 parts magnesium per 22.5 parts copper. The parts here merely reflect weight ratios of the cations in the solution to be precipitated, and the parts do not imply concentration.

Alternatively, or in combination with the group 2a metal or salt thereof, the copper-based particles may be precipitated from a solution comprising zinc metal or salt thereof. For example, the mixture may comprise at least about 0.1 parts zinc, for example, at least about 0.25 parts zinc, at least about 1.0 parts zinc, or at least about 2.0 parts zinc per 22.5 parts copper. The mixture may comprise less than about 3.0 parts zinc, for example, less than about 2.5 parts zinc, or less than about 1.5 parts zinc per 22.5 parts copper. Preferably, the mixture additionally comprises at least about 0.25 parts magnesium, for example, at least about 0.5 parts magnesium, at least about 1.0 parts magnesium, or at least about 2 parts magnesium per 22.5 parts copper. The mixture may comprise less than about 5.0 parts magnesium, for example, less than about 2.5 parts magnesium, or less than about 2 parts magnesium per 22.5 parts copper.

While various precipitation methods can provide small particles of sparingly soluble salts, the product of most manufacturing processes usually includes a small fraction of particles that are unacceptably large. A very small fraction of particles having a particle size above about 1 micron causes, in injection tests on wood specimens, severely impaired injectability. Large particles, e.g., greater than about 1 micron in diameter, should be broken down by wet-milling. Even for processes that provide very small median diameter particles, say a few tenths of a micron in diameter, the precipitation process seems to result in a small fraction of particles that are larger than about 1 micron, and these particles plug up pores and prevent acceptable injectability. The d₉₉, preferably the d_{99.5}, of injectable particles is less than about 1 micron.

Large particles, or large agglomerations of smaller particles, also impose a visible and undesired color to the treated wood, which is generally bluish or greenish. Coloring is usually indicative of poor injectability. Individual particles of diameter less than about 0.5 microns that are dispersed in a matrix do not color a wood product to any substantial degree, but particles having a size greater than 0.5 microns can impart very visible color, and agglomerates on a surface having, when viewed from a direction, greater length and depth dimensions than a 0.5 micron particle have the same undesired coloring as do large particles. In an extreme case of agglomeration, filter cake forms unsightly coloring. Advantageously, the particles of the current invention have sufficient dispersing agents, even when a slurry concentrate is diluted to the strength at which it will be injected into wood, such that formation of agglomerations is avoided.

Certain compounds, particularly basic copper carbonate, copper hydroxide, and copper oxychloride are preferred because they impart less color than do other particles of comparable size. Additionally, the presence of zinc ions and magnesium ions in the copper salt or hydroxide will also reduce color.

WET MILLING: We have surprisingly found that wet ball milling, with milling media of specified characteristics, can advantageously modify particle size and morphology of sparingly soluble copper salts such that a slurry of milled particles is readily injectable into wood. Additionally, wet milling preferentially breaks down rod-shaped particles, which are particularly troublesome.

The preferred milling parameters are: A) mill rotation speed (for a CB Mills KDL™ horizontal mill) is between 400 and 3000 RPM, preferably between 800 and 1600 RPM, for example about 1200 RPM; B) the volume ratio of milling media loading to slurry concentrate loading being between about 0.5:1 to 3:1, preferably between 1:1 and 2:1, for example about 1.5:1; C) flow rate between about 10 and 1000 ml/minute, giving a residence time of between 1 and 60 minutes per pass.

The preferred wet milling comprises a 0.3 to a 1.5 mm milling media having density greater than 3 grams/cm³, for example equal to or greater than 3.8 grams/cm³, or more preferably between about 5.5 grams/cm³ and 8 grams/cm³. A more preferred milling media comprises a 0.3 to 0.8 mm milling media having density equal to or greater than 3.8 grams/cm³, or more preferably between about 5.5 grams/cm³ and 8 grams/cm³. Generally, effective milling can be achieved if only 20% by weight of the milling media is within the preferred or more preferred categories, but having more than 50% by weight of the milling media fall within one or the other of these categories is preferred. Exemplary preferred milling media comprise 0.5 mm to 1.2 mm in diameter zirconium silicate. Exemplary more preferred milling media comprise 0.5 mm to 0.9 mm in diameter zirconium oxide which may contain one or more dopants such as cerium and/or yttrium, and/or magnesia in a stabilizing amount.

Additionally, when using more preferred milling media, the particles in a slurry concentrate can be broken down to injectable size in a matter of minutes to at most a few hours regardless of the particle size of the feedstock. Beneficially all injectable formulations for wood treatment should be wet-milled, even when the “mean particle size” is well within the range considered to be “injectable” into wood. A preferred method of milling comprises the steps of: 1) providing the solid sparingly soluble copper salt (or copper hydroxide) in a concentrated slurry having at least 30% by weight solids, and an effective amount of a surface active agent (dispersant), to a mill; 2) providing a milling media comprising an effective amount of milling beads having a diameter between 0.3 mm and 0.8 mm, wherein these milling beads have a density equal to or greater than 3.5 grams/cm³; and 3) wet milling the material at high speed, for example between 300 and 6000 rpm, more preferably between 1000 and 4000 rpm, for example between about 2000 and 3600 rpm, where milling speed is provided for a laboratory scale ball mill, for a time between about 5 minutes and 300 minutes, preferably from about 10 minutes to about 240 minutes, and most preferably from about 15 minutes to about 60 minutes. It is well within the skill of one in the art to translate milling speed for a laboratory unit to equivalent speeds for pilot units and commercial units. Milling is highly energy intensive, and preferably the feed slurry concentrate has a small particle size distribution, and milling parameters and milling media are optimized, such that the total milling time is between about 3 minutes and about 20 minutes.

Some particles in solution have a tendency to grow over time. Others tend to agglomerate. Therefore, it is advantageous to have a coating on the particle to substantially hinder dissolution of the particle while the particle is slurried, and to make the particles substantially non-interacting and non-agglomerating. But, the coating should not overly hinder dissolution of the particle in the wood matrix.

The milled organic and inorganic particles described above are readily slurried and injected into wood after the milling process. Generally, however, milling is done well before the particles are slurried and injected. The material is advantageously milled in the presence of dispersants in sufficient quantity to stabilize the concentrate during shipping and storage, and also to stabilize the dilute slurry that is eventually prepared and injected into wood. Preferred dispersants are anionic dispersants. Additionally, one or more organic biocides may be added to the composition during the milling process.

The preservatives are often stored and shipped as a powder, as dry granules, as wet-cake, or as a slurry concentrate having greater than 8% copper by weight. These concentrates are then diluted onsite when wood is to be treated. Advantageously, the material is again wet-milled during the preparation of an injectable slurry, to break up any large particles and to ensure the powders and/or granules are solvated. This secondary wet milling is advantageously performed with the same parameters and materials as is the primary milling. This is often not practicable, and secondary milling can be done with less effective milling media, e.g., 2 mm zirconium silicate, 2 mm zirconia, or in a worse case even with ⅛th inch steel balls. It is easier to separate and recover larger milling media from a milled slurry, and this may be preferred in remote locations.

In any of the above-described embodiments, the copper-containing particles can further comprise one or more materials disposed on the exterior of the particles to inhibit dissolution of the underlying sparingly soluble copper material at least for a time necessary to prepare the formulation and inject the prepared wood treatment composition. Additionally or alternatively the acid-soluble particles are coated with a substantially inert coating, for example a thin outer coating of e.g. copper phosphate, or a coating of a polymeric material such as dispersants and/or stabilizers, or with a thin hydrophobic coating of oil and/or of a liquid organic biocide, or any combination thereof. In one embodiment the particles are treated with a dispersing material which is substantially bound to the particles.

The sparingly soluble copper material can be stabilized by a partial or full coating of an inorganic salt of such low thickness that the coating will not substantially hinder particle dissolution in the wood. An exemplary very low solubility salt is copper(II) phosphate (Kₛₚ˜10⁻³⁷). A coating of a very low solubility salt can substantially arrest the dissolution/reprecipitation process by severely limiting the amount of copper that can dissolve. The particles may be wet-milled using a very fine milling material and a fluid containing a source of phosphate ions. Such milling will promote the formation of a thin coating of copper phosphate over the sparingly soluble copper material. In another embodiment, the copper-containing particles after milling can be exposed to a rinse solution that contains between a few hundred ppm of phosphate to about 6% phosphate, for example between 0.1% phosphate to 3% phosphate.

The invention also embraces embodiments where particles are substantially free of an inorganic coating.

Copper-containing particles may alternatively or additionally comprise an organic coating, e.g., a organic layer that partially or completely covers the exterior surface area of the particles. Indeed, in most preferred embodiments of the invention, the surface of the particles has bound thereto at least some dispersants and/or stabilizers, and these qualify as an organic covering. Generally such coatings are extremely thin, with a particle comprising for example between about 0.1% to about 50% by weight, more typically from about 0.5% to about 10%, of the weight of the above-mentioned sparingly soluble salts.

This organic coating can comprise a variety of materials having a variety of functions over and above being an organic layer acting as a protective layer temporarily isolating the sparingly soluble salt from the aqueous carrier to slow dissolution of particles in the slurry, including: 1) an organic biocide carrier, 2) dispersing/stabilizing agents, 3) wettability modifying agents, 3) substantially insoluble organic biocides, or any combinations thereof.

Exemplary organic biocide carrier or solvating agents typically comprise for example light oils and/or solvents.

Exemplary dispersing/stabilizing agents typically comprise polymers functionalized with carboxylates, phosphates, sulfonates, and/or phosphonates, for example polyacrylates and poly(meth)acrylates. The surface active agents are advantageously included in the liquid while milling, and such agents are similarly useful in the product. The preferred dispersants are anionic, or alternately a combination of anionic dispersants and non-ionic dispersants. Particularly preferred are partially neutralized or neutralized poly(meth)acrylate, tridecyl alcohol or other long chain alcohols, xantham gum, and/or a organosiloxane, e.g., a dimethylpolysiloxane, at about 0.05 to 0.3 times the weight of the copper salt or hydroxide. Dispersants can be used at 0.1% to 50%, preferably 0.5% to 20% or 5-10%, based on the weight of a slurry concentrate having 10% to 30% by weight of elemental copper. The slurry can advantageously contain one or more additives to aid wetting, for example surfactants. Surfactants may be in solution, or alternatively may bind to the surface, in which case they are surface-active agents and may function as stabilizers or dispersants. Preferred dispersing agents include a surface active portion that interacts with the copper-containing particle and a second preferably different portion, which operates to inhibit irreversible agglomeration of the copper-based particles. For example, a polyacrylate dispersing agent may include at least one carboxyl group capable of associating, such as electrostatically, with a copper-containing particle and a second, hydrophobic portion that may operate to inhibit the permanent agglomeration of the copper-containing particles. Exemplary dispersing agents may include at least one of a surfactant, a polyacrylate, a polysaccharide, a polyaspartic acid, a polysiloxane, and a zwitterionic compound.

Organic biocides including for example an amine, azole, triazole, or any other organic biocides. Quaternary amine-based organic biocides will cause anionic dispersants to lose effectiveness. A quaternary amine biocide is typically antagonistic to the polyacrylate dispersing agents, and the amount of dispersing agent must be sufficient to not only coat the copper salts but also to neutralize the de-stabilizing effects of the added amine.

Advantageously, if there are a plurality of types of particles in a slurry, the surface active dispersants and stabilizers are compatible and prevent the various types of particles from interacting or agglomerating.

ORGANIC BIOCIDES—As previously stated, the particles may be combined with one or more additional moldicides or more generally biocides, to provide added biocidal activity to the wood or wood products. The absolute quantity of organic biocides incorporated into most wood treatments is very low compared to the amount of inorganic salts, e.g., copper salts. In general, the biocides are present in a use concentration of from 0.1% to 20%, preferably 1% to 5%, based on the weight of the copper salts. The sparingly soluble copper-salt particles of this invention are typically expected to be added to wood in an amount equal to or less than 0.25 pounds as copper per cubic foot. The organic biocide(s) at a 4% loading relative to the copper are present at about 0.16 ounces or about 3 to 4 milliliters of biocide per cubic foot. The organic biocides are often insoluble in water, which is the preferred fluid carrier for injecting the wood preservative treatment into wood, so getting adequate distribution of the biocide within the wood matrix is problematic. In prior art formulations, the wood preservative may be for example admixed in a large excess of oil, and the oil emulsified with water and admixed with the soluble copper for injection into the wood. Problems arise if the injection is delayed, or if the slurry has compounds which break the emulsion, and the like.

In one embodiment, a substantial benefit is that a portion or all of the organic biocides incorporated into the wood preservative treatment can advantageously be coated on to the particles. Preferred preservative treatments comprise copper-based particles having one or more additional organic biocide(s) that are bound, such as by adsorption, to a surface of the particles. Wood and wood products may be impregnated substantially homogeneously with copper-based particles of the invention, each also comprising organic biocidal material bound to the surface of the copper-based particles. By substantially homogeneously we mean averaged over a volume of at least a cubic inches, as on a microscopic scale there will be volumes having particles disposed therein and other volumes within the wood that do not have particles therein. By adhering the biocides on particles, a more even distribution of biocide in ensured, and the copper is disposed with the biocide and therefore is best positioned to protect the biocide from those bio-organisms which may degrade or consume the biocide. The homogenous distribution of preservative function within the wood or wood product is benefited. Finally, a formulation with biocide adhering to particles does not face the instability problems that emulsions face during the formulation and injection phases.

The biocides can be any of the known organic biocides. Exemplary materials having a preservative function include materials having at least one of one or more: azoles; triazoles; imidazoles; pyrimidinyl carbinoles; 2-amino-pyrimidines; morpholines; pyrroles; phenylamides; benzimidazoles; carbamates; dicarboximides; carboxamides; dithiocarbamates; dialkyldithiocarbamates; N-halomethylthio-dicarboximides; pyrrole carboxamides; oxine-copper, guanidines; strobilurines; nitrophenol derivatives; organo phosphorous derivatives; polyoxins; pyrrolethioamides; phosphonium compounds; polymeric quaternary ammonium borates; succinate dehydrogenase inhibitors; formaldehyde-releasing compounds; naphthalene derivatives; sulfenamides; aldehydes; quaternary ammonium compounds; amine oxides, nitroso-amines, phenol derivatives; organo-iodine derivatives; nitrites; quinolines such as 8-hydroxyquinoline including their Cu salts; phosphoric esters; organosilicon compounds; pyrethroids; nitroimines and nitromethylenes; and mixtures thereof.

Exemplary biocides include Azoles such as azaconazole, bitertanol, propiconazole, difenoconazole, diniconazole, cyproconazole, epoxiconazole, fluquinconazole, flusiazole, flutriafol, hexaconazole, imazalil, imibenconazole, ipconazole, tebuconazole, tetraconazole, fenbuconazole, metconazole, myclobutanil, perfurazoate, penconazole, bromuconazole, pyrifnox, prochloraz, triadimefon, triadlmenol, triffumizole or triticonazole; pyrimidinyl carbinoles such as ancymidol, fenarimol or nuarimol; chlorothalonil; chlorpyriphos; N-cyclohexyldiazeniumdioxy; dichlofluanid; 8-hydroxyquinoline (oxine); isothiazolone; imidacloprid; 3-iodo-2-propynylbutylcarbamate tebuconazole; 2-(thiocyanomethylthio) benzothiazole (Busan 30); tributyltin oxide; propiconazole; synthetic pyrethroids; 2-amino-pyrimidine such as bupirimate, dimethirimol or ethirimol; morpholines such as dodemorph, fenpropidin, fenpropimorph, spiroxanin or tridemorph; anilinopyrimdines such as cyprodinil, pyrimethanil or mepanipyrim; pyrroles such as fenpiclonil or fludioxonil; phenylamides such as benalaxyl, furalaxyl, metalaxyl, R-metalaxyl, ofurace or oxadixyl; benzimidazoles such as benomyl, carbendazim, debacarb, fuberidazole or thiabendazole; dicarboximides such as chlozolinate, dichlozoline, iprdine, myclozoline, procymidone or vinclozolin; carboxamides such as carboxin, fenfuram, flutolanil, mepronil, oxycarboxin or thifluzamide; guanidines such as guazatne, dodine or iminoctadine; strobilurines such as azoxystrobin, kresoxim-methyl, metominostrobin, SSF-129, methyl 2-[(2-trifluoromethyl)pyrid-yloxymethyl]-3methoxycacrylate or 2-[.alpha.{[(.alpha.-methyl-3-trifluoromethyl-benzyl)imino]oxy}-o-toly]gly oxylic acid-methylester-O-methyloxime (trifloxystrobin); dithiocarbamates such as ferbam, mancozeb, maneb, metiram, propineb, thiram, zineb or ziram; N-halomethylthio-dicarboximides such as captafol, captan, dichlofluanid, fluorormide, folpet or tolfluanid; nitrophenol derivatives such as dinocap or nitrothal-isopropyl; organo phosphorous derivatives such as edifenphos, iprobenphos, isoprothiolane, phosdiphen, pyrazophos or toclofos-methyl; and other compounds of diverse structures such as aciberolar-S-methyl, anilazine, blasticidin-S, chinomethionat, chloroneb, chlorothalonil, cymoxanil, dichlone, dicomezine, dicloran, diethofencarb, dimethomorph, dithianon, etridiazole, famoxadone, fenamidone, fentin, ferimzone, fluazinam, flusufamide, fenhexamid, fosetyl-alurinium, hymexazol, kasugamycin, methasuifocarb, pencycuron, phthalide, polyoxins, probenazole, propamocarb, pyroquilon, quinoxyfen, quintozene, sulfur, triazoxide, tricyclazole, triforine, validamycin, (S)-5-methyl-2-methylthio-5-phenyl-3-phenyl-amino3,5-dihydroimidazol-4-one (RPA 407213), 3,5-dichloro-N-(3chlro-1-ethyl-1-methyl-2-oxopropyl)₄-methylbenzamide (RH7281), N-alkyl-4,5-dimethyl-2-timethylsilythiophene-3-carboxamide (MON 65500), 4-chloro-4-cyano-N,N-dimethyl-5-p-tolylimidazole-1-sulfon-amide (IKF-916), N-(1-cyano-1,2-dimethylpropyl)-2-(2,4dichlorophenoxyy)-propionamide (AC 382042), or iprovalicarb (SZX 722). Also included are the biocides including pentachlorophenol, petroleum oils, phenothrin, phenthoate, phorate, as well as trifluoromethylpyrrole carboxamides and trifluoromethylpyrrolethioamides described in U.S. Pat. No. 6,699,818; Triazoles such as Amitrole, azocylotin, bitertanol, fenbuconazole, fenchlorazole, fenethanil, fluquinconazole, flusilazole, flutriafol, imibenconazole, isozofos, myclobutanil, metconazole, epoxyconazole, paclobutrazol, (.+−.))-cis-1-(4-chlorophenyl)-2-(1H-1,2,4-triazol-1-yl)-cycloheptanol, tetraconazole, triadimefon, triadimenol, triapenthenol, triflumizole, triticonazole, uniconazole and their metal salts and acid adducts; Imidazoles such as Imazalil, pefurazoate, prochloraz, triflumizole, 2-(1-tert-butyl)-1-(2-chlorophenyl)-3-(1,2,4-triazol-1-yl)-propan-2-ol, thiazolecarboxanilides such as 2′,6′-dibromo-2-methyl-4-trifluoromethoxy-4′-trifluoromethyl-1,3-thiazole-5-carboxanilide; azaconazole, bromuconazole, cyproconazole, dichlobutrazol, diniconazole, hexaconazole, metconazole, penconazole, epoxyconazole, methyl (E)-methoximino>α-(o-tolyloxy)-o-tolyl)!acetate, methyl (E)-2-{2->6-(2-cyanophenoxy)-pyrimidin-4-yl-oxy!phenyl}-3-methoxyacrylate, methfuroxam, carboxin, fenpiclonil, 4(2,2-difluoro-1,3-benzodioxol-4-yl)-1H-pyrrole-3-carbonitrile, butenafine, 3-iodo-2-propinyl n-butylcarbamate; triazoles such as described in U.S. Pat. Nos. 5,624,916; 5,527,816; and 5,462,931; the biocides described in U.S. Pat. No. 5,874,025; 5-[(4-chlorophenyl)methyl]-2,2-dimethyl-1-(1H-1,2,4-triazol-1-yl-methyl)cyclopentanol and imidacloprid, 1-[(6-chloro-3-pyridinyl)-methyl]-4,5-dihydro-N-nitro-1H-imidazole-2-amine; Methyl(E)-2->2->6-(2-cyanophenoxy)pyrimidin-4-yloxy!phenyl!3-methoxyacrylate, methyl(E)-2->2->6-(2-thioamidophenoxy)pyrimidin-4-yloxy!phenyl!-3-methoxyacrylate, methyl(E)-2->2->6-(2-fluorophenoxy)pyrimidin-4-yloxy!phenyl !-3-methoxyacrylate, methyl(E)-2->2->6-(2,6-difluorophenoxy)pyrimidin-4-yloxy!phenyl !-3-methoxyacrylate, methyl(E)-2->2->3-(pyrimidin-2-yloxy)phenoxy-phenyl-3-methoxyacrylate, methyl(E)-2->2->3-(5-methylpyrimidin-2-yloxy)-phenoxy-phenyl-3-methoxy-acrylate, methyl(E)-2->2->3-(phenylsulphonyloxy)phenoxy!phenyl-3-methoxyacrylate, methyl(E)-2->2->3-(4-nitrophenoxy)phenoxy-phenyl-3-methoxyacrylate, methyl(E)-2->2-phenoxyphenyl-3-methoxyacrylate, methyl(E)-2->2-(3,5-dimethylbenzoyl)pyrrol-1-yl-3-methoxyacrylate, methyl(E)-2->2-(3-methoxyphenoxy)phenyl !-3-methoxyacrylate, methyl(E)-2>2-(2-phenylethen-1-yl)-phenyl-3-methoxyacrylate, methyl(E)-2->2-(3,5-dichlorophenoxy)pyridin-3-yl!-3-methoxyacrylate, methyl(E)-2-(2-(3-(1,1,2,2-tetrafluoroethoxy)phenoxy)phenyl)-3-methoxyacrylate, methyl(E)-2-(2->3-(alphahydroxybenzyl)phenoxy!phenyl)-3-methoxyacrylate, methyl(E)-2-(2-(4-phenoxypyridin-2-yloxy)phenyl)-3-methoxyacrylate, methyl(E)-2->2-(3-n-propyloxyphenoxy)phenyl-3-methoxyacrylate, methyl(E)-2->2-(3-isopropyloxyphenoxy)phenyl!-3-methoxyacrylate, methyl(E)-2->2->3-(2-fluorophenoxy)phenoxy!phenyl!-3-methoxyacrylate, methyl(E)-2->2-(3-ethoxyphenoxy)phenyl-3-methoxyacrylate, methyl(E)-2->2-(4-tert-butylpyridin-2-yloxy)phenyl!-3-methoxyacrylate; Fenfuram, furcarbanil, cyclafluramid, furmecyclox, seedvax, metsulfovax, pyrocarbolid, oxycarboxin, shirlan, mebenil (mepronil), benodanil, flutolanil; Benzimidazoles, such as carbendazim, benomyl, furathiocarb, fuberidazole, thiophonatmethyl, thiabendazole or their salts; Morpholine derivatives, such as tridemorph, fenpropimorph, falimorph, dimethomorph, dodemorph; aldimorph, fenpropidine and their arylsulphonates, such as, for example, p-toluenesulphonic acid and p-dodecylphenylsulphonic acid; Benzothiazoles, such as 2-mercaptobenzothiazole; Benzamides, such as 2,6-dichloro-N-(4-trifluoromethylbenzyl)-benzamide; oxazolidine, hexa-hydro-5-triazines, N-methylolchloroacetamide, paraformadehyde, nitropyrin, oxolinic acid, tecloftalam; Tris-N-(cyclohexyldiazeneiumdioxy)-aluminum, N-(cyclohexyldiazeneiumdioxy)-tributyltin, N-octyl-isothiazolin-3-one, 4,5-trimethylene-isothiazolinone,4,5-benzoisothiazolinone, N-methylolchloroacetamide; Pyrethroids, such as allethrin, alphamethrin, bioresmethrin, byfenthrin, cycloprothrin, cyfluthrin, decamethrin, cyhalothrin, cypermethrin, deltamethrin, alpha-cyano-3-phenyl-2-methylbenzyl 2,2-dimethyl-3-(2-chloro-2-trifluoro-methylvinyl)cyclopropane-carboxylate, fenpropathrin, fenfluthrin, fenvalerate, flucythrinate, flumethrin, fluvalinate, permethrin, resmethrin and tralomethrin; Nitroimines and nitromethylenes, such as 1->(6-chloro-3-pyridinyl)-methyl!-4,5-dihydro-N-nitro-1H-imidazol-2-amine (imidacloprid), N->(6-chloro-3-pyridyl)methyl-!N.sup.2-cyano-N¹-methylacetamide (NI-25); Quaternary ammonium compounds, such as didecyldimethylammonium salts; benzyldimethyltetradecylammonium chloride, benzyldimethyldodecylammonium chloride, didecyldimethaylammonium chloride; Phenol derivatives, such as tribromophenol, tetrachlorophenol, 3-methyl-4-chlorophenol, 3,5-dimethyl-4-chlorophenol, phenoxyethanol, dichlorophene, o-phenylphenol, m-phenylphenol, p-phenylphenol, 2-benzyl-4-chlorophenol and their alkali metal and alkaline earth metal salts; iodine derivatives, such as diiodomethyl p-tolyl sulphone, 3-iodo-2-propinyl alcohol, 4-chloro-phenyl-3-iodopropargyl formal, 3-bromo-2,3-diiodo-2-propenyl ethylcarbamate, 2,3,3-triiodoallyl alcohol, 3-bromo-2,3-diiodo-2-propenyl alcohol, 3-iodo-2-propinyl n-butylcarbamate, 3-iodo-2-propinyl n-hexylcarbamate, 3-iodo-2-propinyl cyclohexyl-carbamate, 3-iodo-2-propinyl phenylcarbamate; Microbicides having an activated halogen group, such as chloroacetamide, bronopol, bronidox, tectamer, such as 2-bromo-2-nitro-1,3-propanediol, 2-bromo-4′-hydroxy-acetophenone, 2,2-dibromo-3-nitrile-propionamide, 1,2-dibromo-2,4-dicyanobutane, .beta.-bromo-.beta.-nitrostyrene; and combinations thereof. These are merely exemplary of a few classes of the known and useful biocides, and the list could easily extend for pages.

Preferred biocides for wood preservation include quaternary ammonium compounds including for example didecyldimethylammonium salts; azoles/triazoles including for example N-alkylated tolytriazoles, metconazole, imidacloprid, hexaconazole, azaconazole, propiconazole, tebuconazole, cyproconazole, bromoconazole, tridemorph, tebuconazole; moldicides; HDO available commercially by BASF, or mixtures thereof.

STORING AND SHIPPING THE PARTICLES: The particles are typically formulated into a dilute slurry in water prior to injection. The injected solution typically comprise dispersants and/or surfactants. Generally, the slurry injected into wood has about 0.05% to about 1.5% copper, where the copper is in the form of copper hydroxide, or less preferably is in the form of a sparingly soluble basic copper salt. Care should be taken in preparing pre-mixed concentrates, however, because a pre-mix that is stable at 1% copper may not be stable if the premix is diluted to 0.1% copper, depending on the quality of the diluent water. Generally, it is economically wasteful for such a dilute solution to be manufactured and subsequently shipped to various wood preservation plants. The injectable copper-containing particles are therefore prepared in a more concentrated form.

The particles may be shipped in a dry form or in a wet form. The milled particles may be transported to a site as a dry material, as a concentrated slurry, in a very concentrated paste, or as a thixotropic gel. This material is then formed into an injectable slurry, and then after some indeterminate storage time the particles may be injected into wood. The slurry formulations mentioned can be prepared in a manner known per se, for example by mixing the active compounds with the liquid carrier, and including emulsifier, dispersants and/or binders or fixative, and other processing auxiliaries.

Slurry Concentrate or Wet-cake—If the wood treatment is to be manufactured, stored, or transported in a wetted form, it is beneficially in a concentrated form to minimize the volume and expense of handling water. Preferably the concentrated slurry or paste (for shipping and storing, for example, comprises between 5% and 80% by weight, for example between about 15% and 40%, of sparingly soluble copper-containing particles, with the remainder of the concentrated slurry or paste beneficially being principally a fluid carrier. The fluid carrier beneficially comprises one or more additives as discussed for the slurry, including anti-oxidants, surfactants, disbursing agents, other biocidal salts and compounds, chelators, corrosion inhibitors, e.g., phosphate and/or borate salts, alkali metal hydroxides and/or carbonates, antifreeze, and the like. The concentration of these additives will depend in part on the degree to which the slurry is expected to be diluted to make a commercially useful injectable slurry having the proper copper loading for the types of wood. The reduced moisture particles may be diluted, such as by hydration with water or combination with another liquid. Generally, dilution may be with water, beneficially fresh water. The slurries, pastes, or granules may be diluted and/or dispersed in water with mixing or agitation, such as mechanically stirring with or without ultrasonic energy.

Dry Particles and Dry Mix For Slurry—The particles of this invention can be formulated and transported as a dry material, e.g., as a wettable powder, as dispersible granules, and even as larger tablets. The material of the invention offers reduced shipping costs and improved ease of handling compared to known preservative materials. A user may receive the material and, if granules are present, disperse the granules, thereby preparing a flowable material comprising a plurality of copper-based particles. Mechanical agitation and/or mixing may be used to disperse the granules.

The wettable powder, dispersible granules, or tablets advantageously comprise the biocidal copper-containing particles and those additives such as are described as being present in the slurry, including for example one or more of anti-oxidants, surfactants, disbursing agents/stabilizing agents, chelators such as salts of ETDA, basic compounds, sequestrants such as salts of HEDP, and the like. The additives can be coated onto the sparingly soluble copper-based particles and/or can be formed from second particles. If in second particles, then the phenomena that different slurry concentrations need different amounts of dispersants can easily be addressed. The dry-mix material advantageously has all necessary components in a single mix, and each component is present in a range that is useful when the dry mix is formed into a sprayable or injectable slurry. The mixture may optionally but preferably incorporate a granulating material, which is a material that when wet holds a plurality of particles together in the form of a granule or tablet, but that dissolves and releases the individual particles on being admixed with the liquid carrier. Granules are preferred because of dust problems and also the ease of measuring and handling a granular mixture. Granulating agents can be simple soluble salts, for example alkali carbonates, that are sprayed onto or otherwise is admixed with the particle material.

One example of a biocide composition in granular or tablet form, which rapidly disintegrates and disperses in water, includes, e.g., about 50 parts particle copper hydroxide and/or other sparingly soluble copper salts, about 10 to about 40 parts salts, e.g., alkali salts, carbonate and/or bicarbonate salts, about 1 to about 20 parts solid chelators/sequestrants, about 5 to about 50 parts stabilizers and/or dispersants, and optionally up to about 20 parts filler. Another exemplary dissolvable biocide granule comprises: 1) about 50-75% of a first finely-divided (submicron) particle copper hydroxide and/or other sparingly soluble copper salts; 2) about 2-30% of a stabilizer and/or dispersing agent; 3) about 0.01-10% of a wetting agent; 4) about 0-2% of an antifoaming agent; 5) about 0-5% of a diluent; and optionally 6) about 0-5% of a chelating agent. One embodiment of the invention relates to a dry mix material having a copper content of at least about 8% by weight. Another embodiment of the invention relates to a dry material having a copper content of at least about 15% by weight. A preferred material includes a plurality of copper-containing particles. The material may be shipped, such as in granular form, to a location at which the material is prepared for use a wood preservative. The material may also comprise at least one of a wetting agent, a dispersing agent, a diluent which may be a particle comprising organic biocides thereon, an antifoaming agent, and an additional material having a biocide function.

Another preferred material includes a plurality of copper-containing particles in the form of granules which also comprises at least one of a wetting agent, a dispersing agent, a diluent, an antifoaming agent, and an additional material having a biocide function.

In one embodiment, the material is a granular material comprising about 50% to 70%, for example 58% copper hydroxide or other sparingly soluble copper salts, about 10% to 25%, for example 18% of a dispersing agent, such as Borresperse™ NA (available from Borregare Lignotech, Wis.), about 1 to 8%, e.g., about 4% of a wetting agent, such as Morwet™ IP (available from Akzo Nobel, New York), and optionally about 10% to about 30% filler; optionally from 0.05% to 7% alkali hydroxides, alkali carbonates, alkali phosphates, and/or alkali borates; optionally 0.05% to 5% salts of a sequestrant, for example HEDP, and optionally from 0.05% to 2% antifoaming agents.

In one embodiment, the dry-mix material is a granular material comprising about 40 to about 80% by weight of a sparingly soluble copper salt, e.g., copper hydroxide, about 5% to about 30% of a dispersing agent, such as Borresperse NA, about 1% to about 10% of a wetting agent, such as Morwet IP, and optionally about 5% to about 30% of: an inert filler which may additionally comprise organic biocides absorbed thereon, dissolution aids, pH modifiers such as alkali hydroxides, and the like. In one embodiment, the material is a granular material comprising about 58% copper hydroxide, about 18% of a dispersing agent, such as Borresperse NA, about 4% of a wetting agent, such as Morwet IP, and optionally about 20% of a filler or dissolution aid, for example attapulgite clay.

In one embodiment, the material comprises A) about 30% to 70% by weight of a slightly soluble copper salt, e.g., copper hydroxide, for example, about 35% to 65%, such as about 38% to about 61% of a slightly soluble copper salt, in particle form; B) about 10% to 35% by weight, such as about 15% to about 30% of at least one dispersing agent, e.g., lignosulfonates or polyacrylates; C) between about 2.5% to 20% by weight, such as about 5% to 15% of at least one wetting agent, for example, a surfactant, e.g., Morwet IP; D) between about 5% to about 25% by weight, such as about 10% to 20% of at least one diluent, for example soluble and insoluble diluents, such as those used in agricultural products, e.g., such as an attapulgite clay or other particulate carrier particles comprising organic biocide thereon, soluble salts, and/or alkali bases; E) between about 0.05% to 7.5% by weight, such as about 0.1% to about 5%, of at least one antifoam agent; and optionally F) about 2.5% to about 25%, alternatively less than about 7.5%, such as less than about 5% by weight, of water.

Another aspect of the invention relates to slurry concentrate material comprising a copper content of at least about 15%, for example, at least about 20%, such as at least about 30% by weight. In one embodiment, the material may have a copper content of about 35% by weight. The material may have a copper content of less than about 50%, for example, less than about 45%, such as less than about 40% by weight. Preferably, the material comprises a plurality of copper-based particles, which may contribute substantially all of the copper content of the material. The material may comprise a plurality of granules each comprising a plurality of copper-based particles. The copper-based particles, such as a surface thereof, may be associated with a dispersing agent.

In another embodiment, a useful slurry concentrate comprises 10% to 30% as elemental copper in sparingly soluble copper salts, 2 to 15% Borresperse NA, Morwet EFW at 0.02% to 1%, all percents by weight, with a balance of water and small (less than 0.5%) amounts of optional alkali, defoamer, and scale inhibitor. Another exemplary formula can comprise 10% to 30% as elemental copper in sparingly soluble copper salts, 2% to 30% neutralized or partially neutralized polyacrylate, e.g., Soakland PA30-CL™ and Soakland PA30-CL-PN™ (available from BASF) (45% active), and 0.02% to 1% wetting agent, e.g., Stepwet DF-95 (available from Stepan Co., Northfield, Ill.), and 0.2% to 5% a naphthalene sulfonate dispersant, e.g., Galoryl DT-120 (available from Nufarm), and optionally less than 0.1% defoamer, e.g., Drewplus L-768™ (available from Ashland Chemical). Another useful slurry concentrate can comprise 10% to 30% as elemental copper in sparingly soluble copper salts, 2 to 15% Borresperse NA, Morwet EFW at 0.02% to 1%, all percents by weight, with a balance of water and small (less than 0.5%) amounts of optional alkali, defoamer, and scale inhibitor. Another exemplary formula comprises 10% to 30% as elemental copper in sparingly soluble copper salts, 2% to 30% neutralized or partially neutralized polyacrylate, e.g., Soakland PA30-CL™ and Soakland PA30-CL-PN™ (available from BASF) (45% active), and 0.02% to 1% wetting agent, e.g., Stepwet DF-95 (available from Stepan Co., Northfield, Ill.), and 0.2% to 5% a naphthalene sulfonate dispersant, e.g., Galoryl DT-120 (available from Nufarm), and optionally less than 0.1% defoamer, e.g., Drewplus L-768™ (available from Ashland Chemical).

The material can be provided as a thixotropic composition having a gelling material, dispersants, and optionally one or more of organic biocides, surfactants, sequestrants, alkali bases, and the like.

Generally, an excess of dispersing agents is desired such that the amount of dispersing agent will be adequate to prevent agglomeration of particles at the lowest concentration the material may be prepared as. An amount of dispersant which is adequate to stabilize a slurry having 1% by weight copper will often not be sufficient to stabilize the slurry is a concentrate having 0.1% by weight copper is formulated. The end result is that slurries often comprise an excess of dispersing agents, since injectable slurries comprising anywhere between 0.1 and 2% by weight as copper may be formed from a single slurry concentrate.

The slurry can additionally comprise soluble copper-amine compounds, e.g., ammoniacal copper, copper-monoethanolamine complex, or a copper ethylenediamine complex. Alternately, a slurry can be substantially free of or free of solubilized copper amine compounds. Again, if copper amine compounds are present in a slurry concentrate, for example by partially dissolving a slurry to reduce the particle size thereof, care should be taken in preparing an injectable slurry such that the pH of the slurry does not approach the range where the copper amine may precipitate, e.g., at about pH 7.5 or at about pH 13.

METHOD OF PRESERVING WOOD: Another aspect of the invention relates a method of preserving wood or a wood product comprising injecting into wood or dispersing into a wood product one or more of the biocidal particles of this invention. Preferred methods of preserving wood require the sparingly soluble copper salt and/or hydroxide particles to be formed into an aqueous slurry, typically with a dispersed particle concentration sufficient to provide between about 0.1% to 2% by weight copper based on the weight of the slurry. This slurry is then injected into wood.

Advantageously, a vacuum is drawn on the wood prior to, and this slurry is either mixed with the wood material or fibers before bonding, or more preferably injected into the wood material or fibers, followed by bonding. Advantageously, a vacuum is drawn on the wood prior to contacting the wood with the preservative slurry. Heat may be applied. The vacuum removes a portion of the air in the wood, so that compressed air will not prevent the slurry from reaching the center of wood being treated. If a vacuum is maintained for a sufficient time, the wood will become measurably drier, and a lower concentration of copper in a slurry may be used.

Advantageously, after contacting and while substantially immersing the wood in the preservative slurry, the pressure is increased to between 20 psig and about 200 psig, typically around 100 psig. Advantageously, the increase in pressure is controlled so as to make the process take several minutes. After letting the slurry contact the wood under pressure for between 5 minutes and 200 minutes, typically between 30 minutes and 90 minutes, the slurry is siphoned from the treating vessel which contains the wood.

The material of this invention is useful for wood, and also for wood products, e.g., wood composites. Exemplary wood products include oriented strand board, particle board, medium density fiberboard, plywood, laminated veneer lumber, laminated strand lumber, hardboard and the like. Preferred methods of preserving wood composites require the sparingly soluble copper salt and/or hydroxide particles to be formed into a slurry, and this slurry is either mixed with the wood material or fibers before bonding, or more preferably injected into the wood material or fibers, followed by bonding. Advantageously, a vacuum is drawn on the wood prior to contacting the wood with the preservative slurry. Advantageously, after contacting and while substantially immersing the wood in the preservative slurry, the pressure is increased to between 20 psig and about 200 psig, typically around 100 psig.

### EXAMPLES

The following examples are merely indicative of the nature of the present invention, and should not be construed as limiting the scope of the invention, nor of the appended claims, in any manner.

### Example 1

### Injection of Formulated Slurry into Wood

The following are representative slurries that were prepared and sent to another lab to determine whether the particles were suitable for injection into wood: 1) a formulated (having dispersants, etc) very concentrated copper hydroxide product, where the d₅₀ of the particles was 0.17 microns, and the % copper (by weight) in the product was 37.6% (for comparison, the % copper in pure copper hydroxide is 65%); 2) a slurry of copper hydroxide particles in water, where the d₅₀ of the particles was 0.17 microns, and the % copper in the slurry was 20.5%; 3) a comparative material comprising wet copper hydroxide particles, where the d₅₀ of the particles was 2.7 microns, and the % copper in the comparative product was 58.6%; 4) a stable aqueous gel comprising wet-milled copper hydroxide particles and dispersants, where the d₅₀ of the particles was 0.15 microns, and the % copper in the slurry was 11.7%, where the gel fully disperses when diluted with at least an equal weight of water; 5) a formulated slurry of milled copper hydroxide particles, where the d₅₀ of the particles was 0.15 microns, and the % copper in the product was 12.8%; and 6) a granulated product comprising milled copper hydroxide particles, dispersants, and other materials, where the d₅₀ of the particles was about 0.15 microns, and the % copper in the slurry was 37.5%. Advantageously the sparingly soluble copper salt or copper hydroxide comprises less than 40 ppm lead, based on the weight of the sparingly soluble copper salt or copper hydroxide. The first sample comprised 24 ppm lead, based on the weight of copper hydroxide.

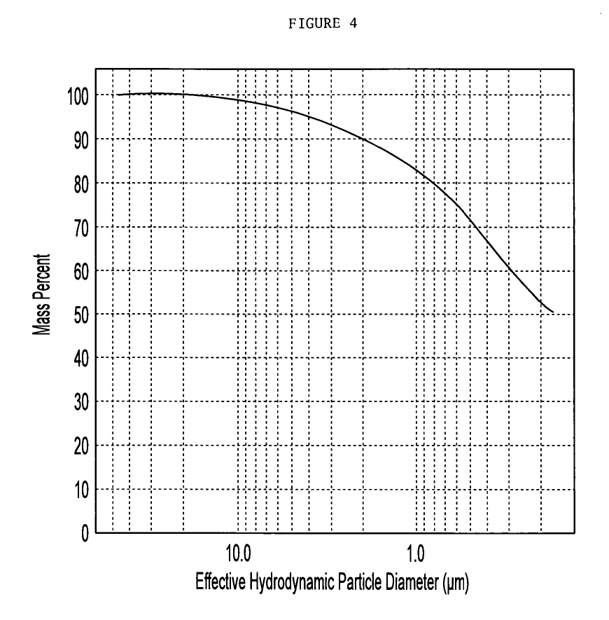

Of these, only the first product (#1) was injected into wood (vacuum for 15 minutes, then 30 minutes at about 100 psig pressure), and the injection was successful with almost 100% penetration. FIG. 4 shows the approximate particle size distribution of the copper hydroxide particles in the slurry. The un-formulated slurry (#2) and the comparative 2.7 micron material (#3) could not be made into slurries stable enough to be injected into wood.

### Comparative Example 2

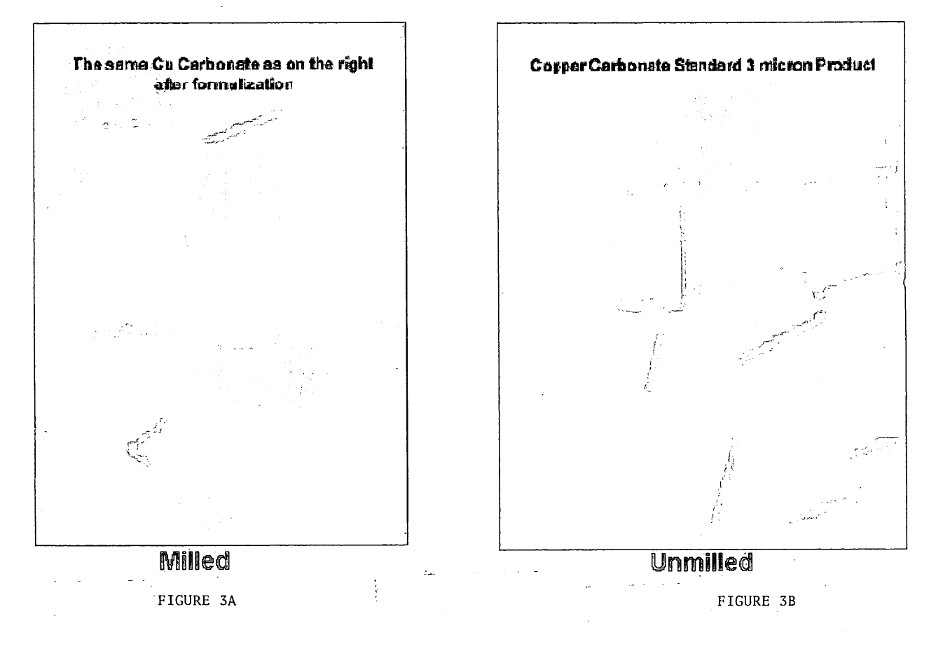

This comparative example and subsequent example show the effectiveness of the milling media and process on the particle size distribution of inorganic copper salts. A slurry comprising copper carbonate having a d₅₀ of 2.5 microns was prepared, and this material was injected onto wood. FIG. 3 shows wood samples after trying to inject this copper carbonate having a d₅₀ of 2.5 microns on the left, and FIG. 3 also shows wood samples after injecting a milled slurry having a d₅₀ between 0.15 and 0.2 microns on the right. The aqueous copper carbonate slurry having a d₅₀ of 2.5 microns plugged the surface of the wood and made an unsightly blue-green stain, and there was little penetration of copper hydroxide into the wood. The aqueous copper carbonate slurry having a d₅₀ of about 0.17 microns did not show evidence of plugging the surface, was only slightly tinted in color, and there was complete penetration of copper into the wood.

### Example 3

### Milling Sub-Micron Copper Hydroxide

A sample of the copper hydroxide particles used in the formulation of Champ Formula 11® (available from Phibro-Tech Inc., Fort Lee, N.J.)—copper hydroxide particles having a d₅₀ of 0.28 microns and a d₈₀ of 1 micron and formulated with about 2 to 6 parts by weight of dispersants/stabilizers/rheology aids per weight of copper hydroxide—was wet milled in a Union Process Model 01-HD mill at 500 RPM using ⅛th inch steel balls as the grinding medium. The total milling time was 60 minutes, though samples were taken at selected intervals during this time. The d₅₀ declined only slightly, indicating the milling with the coarse milling material had little effect on the size of sub-micron particles. The fraction of material with a diameter less than 1 micron increased over the 60 minutes of milling, however, from 80% at time zero to 88% at 30 minutes, and further to 89% with an additional 30 minutes of milling. The fraction of material with a diameter less than 2 microns increased even more over the 60 minutes of milling, from 88% at time zero to 98% at 30 minutes, and further to 99% with an additional 30 minutes of milling. Most particle size reduction occurs in 30 minutes or less.

| Milling | | | |
|---|---|---|---|
| time | d50, μ | Wt % @ diameter <1μ | Wt % @ diameter <2μ |
| 0 | 0.28 | 80 | 88 |
| 5 | — | | |
| 10 | 0.26 | 81 | 89 |
| 20 | 0.26 | 85 | 96 |
| 30 | 0.24 | 88 | 98 |
| 60 | 0.25 | 89 | 99 |

In a second study, a sample of the copper hydroxide particles used in the formulation of Champ Formula II® (available from Phibro-Tech Inc., Fort Lee, N.J.), having a d₅₀ of 0.28 microns and a d₈₀ of 1 micron was wet milled in a CB MILLS KDL™ pilot unit mill at 1200 RPM using 0.6 to 1 mm zirconium silicate as the grinding medium, where the media loading was 1120 mls. and the process slurry volume was 700 mls. After 3.3 minutes of milling, there was no appreciable change in the d₅₀, but the fraction of material having a diameter less than 1 micron increased from 85 wt. % to 97 wt. %. An additional 15 minutes of milling resulted in a substantial and surprising decrease in the d₅₀ from about 0.28 microns to about 0.21 microns, and the fraction of material having a diameter less than 1 micron increased to 100 wt. %.

A third test resulted in the d₅₀ decreasing from 0.28 microns to 0.22 microns, and the fraction of material having a diameter less than 1 micron increasing from 86% to 100%, after 28 minutes of milling. A fourth test resulted in the d₅₀ decreasing from 0.28 microns to 0.19 microns, and the fraction of material having a diameter less than 1 micron increasing from 86% to 100%, after 28 minutes of milling. A fifth test resulted in the d₅₀ decreasing from 0.28 microns to 0.22 microns, and the fraction of material having a diameter less than 1 micron increasing from 86% to 99%, after 14 minutes of milling.

The tests showed that milling with ⅛th inch steel balls and the milling material was effective at reducing the fraction of copper hydroxide having a diameter greater than 2 microns after a reasonable milling time (30 minutes), but that this milling only gradually attrited the material greater than 1 micron in diameter, and milling with this media had only a slight affect on the d₅₀. While the density of the steel balls is high, the size of the balls is too large to obtain an injectable slurry (that will not form filter cake on the surface of wood during injection) in a commercially reasonable time, e.g., 15 to 30 minutes of milling.

On the other hand, milling with 0.7 to 0.9 mm glass beads had little effect on the d₅₀. These beads do not have the required density and toughness to be effective (i.e., providing the desired particle size distribution within a commercially acceptable time) milling agents for copper hydroxide.

Milling with 0.6 to 1 mm zirconium silicate, on the other hand, substantially eliminated the amount of material having a diameter greater than 1 micron after 15 to 30 minutes of milling, and also had a significant effect on the d₅₀. This latter milling environment was therefore attriting copper hydroxide particles to sizes below 0.2 microns.

Similar tests were done on samples of Champ Formula II® (available from Phibro-Tech Inc., Fort Lee, N.J.), which included not only the copper hydroxide particles tested above (and about 5 to 7% of a different dispersant) but also an increased amount of a suspending agent, believed to be xantham gum (RHODOPOL 23 (available from Rhodia, Cranberry, N.J.)) in an amount effective to create a stable thickened slurry of the copper hydroxide in water. Incorporation of the different dispersant and suspending agent decreased to 14 minutes the time to reduce the d₅₀ to 0.2 microns and to eliminate all particles having a diameter greater than 1 micron.

Effective milling is best achieved with milling material having a diameter less than about 1 mm but also having a density equal to or greater than that of zirconium silicate (i.e., greater than about 3.8 g/cc). Wet milling with 0.6 to 1 mm zirconium silicate milling material for between 15 and 30 minutes will greatly increase the injectability of the copper hydroxide particles into wood, and will greatly reduce the amount of material plated on the surface of wood. Milling with a denser material, for example 0.6 to 1 mm zirconium oxide, or more preferably 0.5 mm zirconium oxide, as the milling medium should produce a product having less than 0.5%, land likely approximately 0%, of copper hydroxide material plated on the surface of the wood.

### Example 4

### Milling Sparingly Soluble Copper Salts with 0.5 mm Zirconium Silicate

The Champ DP® material was placed in a mill with about a 50% by volume loading of 2 mm zirconium silicate milling beads. Samples were removed intermittently and the particle size distribution was determined. Wet milling with 2 mm zirconium silicate milling media had no effect—wet milling for days resulted in only a very slight decrease in particle size, a small shift in the particle size distribution, but the material was not injectable into wood.

In contrast, five samples of particle copper salts made following standard procedures known in the art were milled with 0.5 mm milling material. The first two samples were copper hydroxide—one with an initial particle size d₅₀ of <0.2 microns (˜0.17 microns), and the second with an initial d₅₀ of 2.5 microns. A basic copper carbonate (BCC) salt was prepared and it had an initial d₅₀ of 3.4 microns. A tri-basic copper sulfate (TBS) sample was prepared and this material has a d₅₀ of 6.2 microns. Finally, a copper oxychloride (COc) sample was prepared and this material has an initial d₅₀ of 3.3 microns. Selected surface active agents were added to each slurry, and the initial slurries were each in turn loaded into a ball mill having 0.5 mm zirconium silicate (density 3.8 grams/cm³) at about 50% of mill volume, and milled at about 2600 rpm for about a half an hour. The particle size distribution of the milled material was then determined. The particle size distribution data is shown in Table 1. It can be seen that even with the relatively modest zirconium silicate milling media, injectable compositions were obtained in about 30 minutes milling time or less. Further, the rate of particle size attrition is so great that there is no need to use expensive precipitation techniques to provide a feedstock having a sub-micron d₅₀. The initial d₅₀ of the feed material ranged from 0.2 microns to over 6 microns, but after 15 to 30 minutes of milling, each of the copper salts were injected into wood samples with no discernible plugging.

Milling with the more preferred zirconium oxide milling beads will provide a smaller d₅₀ and will further reduce the amount of material, if any, having a diameter greater than 1 micron. Particle biocides have an advantage over dispersed or soluble biocides in that the material leaches more slowly from wood than would comparable amounts of soluble biocides, and also about the same or more slowly than comparable amounts of the same biocide applied to the same wood as an emulsion.

TABLE 1
Particle Size Distribution Before/After Milling
(0.5 mm Zirconium Silicate)

| Material | d50 | % <10μ | % <1μ | % <0.4μ | % <0.2μ |
|---|---|---|---|---|---|
| Cu(OH)₂, before | <0.2 | 99% | 84% | 64% | 57% |
| milling | | | | | |
| Cu(OH)₂, after milling | <0.2 | 99% | 97% | 95% | 85% |
| Cu(OH)2, before | 2.5 | 99% | 9% | — | — |
| milling | | | | | |
| Cu(OH)2, after milling | 0.3 | 99.7% | 95% | 22% | —% |
| BCC*, before milling | 3.4 | 98% | 1.2% | — | — |
| BCC*, after milling | <0.2 | 99% | 97% | 97% | 87% |
| TBS*, before milling | 6.2 | 70% | 17% | — | — |
| TBS*, after milling | <0.2 | 99.5% | 96% | 91% | 55% |
| COc*, before milling | 3.3 | 98.5% | 3% | — | — |
| COc*, after milling | 0.38 | 99.4% | 94% | 63% | — |

### Example 5

### Injecting Milled Copper Salt Slurries into Wood

Slurries of the above milled sparingly soluble copper salts were successfully injected into standard 0.75 inch cubes of Southern Yellow Pine wood. The injection procedures emulated standard conditions used in the industry.

FIG. 3 shows representative photographs showing the comparison of the unacceptable product, which had a d₅₀ of 2.5 microns yet still plugged the wood, is shown in comparison with blocks injected with the product milled according to the process of this invention as described in Example 3. FIG. 3 shows the clean appearance of the wood blocks injected with the milled copper hydroxide, to compare with the photograph of the wood samples injected with the un-milled (d₅₀<0.2 micron) copper hydroxide. Unlike the blocks injected with un-milled material, wood blocks injected with milled material showed little or no color or evidence of injection of copper-containing particle salts.

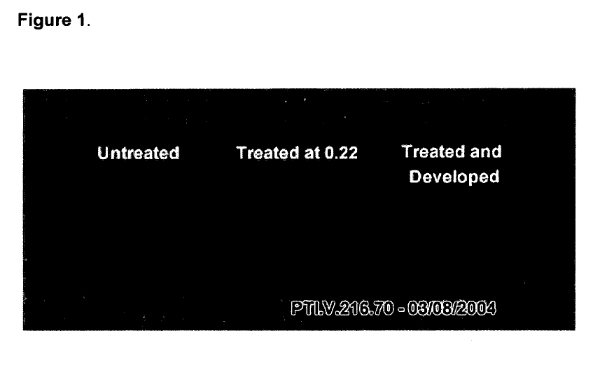

Copper development by calorimetric agents (dithio-oxamide/ammonia) showed the copper to be fully penetrated across the block in the sapwood portion. FIG. 1 shows the penetration of injected particle copper hydroxide developed with dithio-oxamide in the third picture. The stain corresponds to copper. It can be seen in FIG. 1 that the copper is evenly dispersed throughout the wood. Subsequent acid leaching and quantitative analysis of the copper from two blocks showed that loadings of about 95% and about 104% of expectation (or essentially 100% average of expectation) had occurred. At 100% loading, values of 0.22 lb/ft³ of copper would be obtained.

### Example 6

### Leaching Copper from Treated Wood

Copper leaching rates from the wood samples prepared in Example 4 were measured following the AWPA Standard Method E11-97. There are two comparative examples—leaching data was obtained from a wood block preserved with a prior art soluble solution of copper MEA carbonate and from a prior art wood block preserved with CCA. The leach rates of the various wood blocks treated with the preservatives prepared according to this invention were far below the leach rates of wood treated with soluble copper carbonate and were even below leach rates of samples treated with CCA.

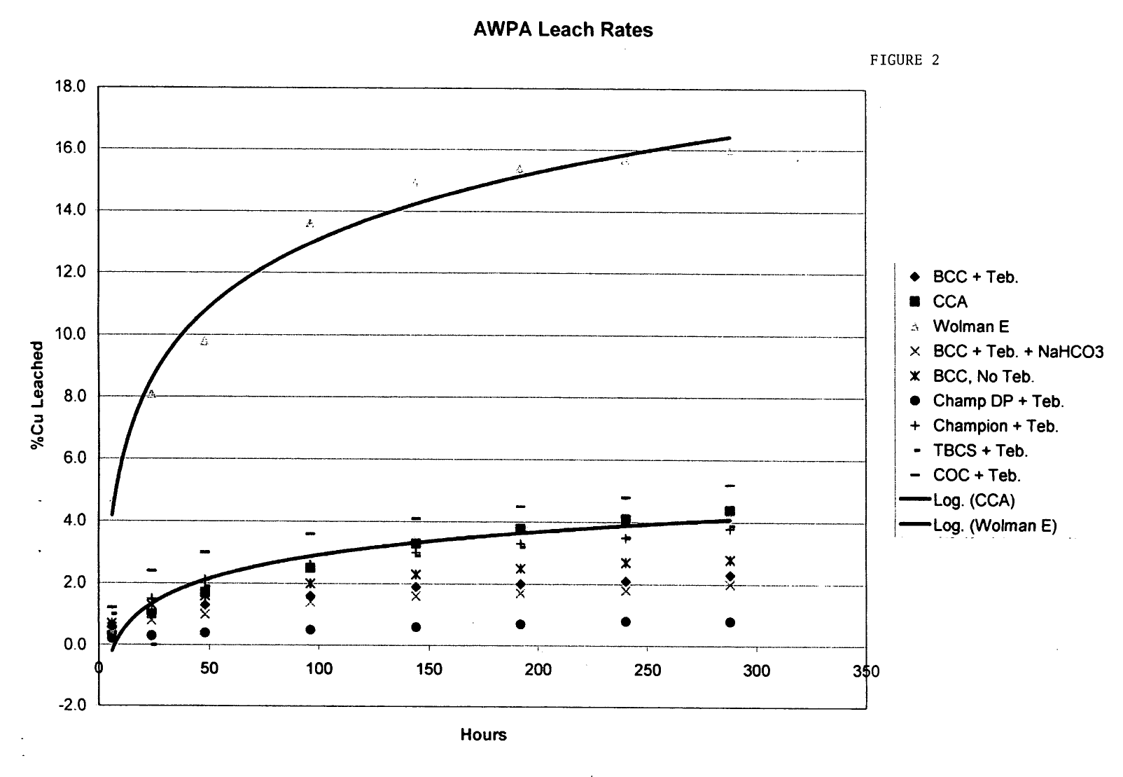

Leaching data from wood was measured following the AWPA Standard Method E11-97 for the following preservative treatments, where, unless specified, the tebuconazole (TEB) concentration was added as an emulsion at 3% of the weight of the added copper: A) TEB and injected basic copper carbonate particles; B) traditionally CCA-treated wood (as a control); C) TEB and copper methanolamine carbonate (as a control, believed to approximate the currently available Wolman E treatment); D) TEB and injected basic copper carbonate particles and with sodium bicarbonate buffer; E) Injected basic copper carbonate particles; F) TEB and injected copper hydroxide particles modified with zinc and magnesium; G) about 5% TEB and injected copper hydroxide particles modified with phosphate coating; H) TEB and injected tri-basic copper sulfate particles; and I) TEB and injected copper oxychloride particles. The leaching data for the various particle slurries and from two controls are shown in FIG. 2.

The total copper leached from wood preserved with copper-MEA-carbonate was 5.7% at 6 hours, 8.5% at 24 hours, 11% at 48 hours, 22% at 96 hours, 36% at 144 hours, 49% at 192 hours, 62% at 240 hours, 69% at 288 hours, and 76% at 336 hours. The amount of copper leached from copper hydroxide particles was 0.4% at 6 hours, 0.6% at 24 hours, 0.62% at 48 hours, 1.0% at 96 hours, 1.6% at 144 hours, 2.1% at 192 hours, 3.2% at 240 hours, 3.4% at 288 hours, and 3.7% at 336 hours. The difference in leach rate was greater than a factor of 20.

The leaching data is generally consistent within the small amount of copper leached from these wood samples. Using the copper leach rate of CCA as a standard, and viewing the total leached copper at 96 and 240 hours as representative, the leach rate ratios given by the “total leached copper to total CCA-leached copper” is given in Table 2 below.

Of the sparingly soluble salts used, the leach rate, in descending order, is as follows: copper MEA carbonate (comparative)>>copper oxychloride>tri-basic copper sulfate and/or copper hydroxide with phosphate>basic copper carbonate>copper hydroxide with Zn and Mg. The isoelectric point of copper oxychloride is about 5 to about 5.5, and the isoelectric point of tri-basic copper sulfate is about 6 to about 6.5. As these materials are very poor bases, the higher leach rates from the materials is consistent with expected higher solubility at lower pH values. The presence of TEB reduced leach rates from basic copper carbonate by about 20%, most likely due to TEB partially coating particles. A buffering system, sodium bicarbonate, reduced the leach rates from TEB/basic copper carbonate by about 10% relative to a preservative without the buffer.

Use of the small diameter milling material, preferably 0.3 mm to 0.7 mm, is essential to make a product that can be confidently sold for injection into wood.

### Example 7

### Toxicity Test

A sample of treated wood was sent to an outside source for short-duration toxicity testing. The results suggest there is no difference in the Threshold Toxicity between wood treated with a copper MEA carbonate/tebuconazole formulation and wood treated with a identical loading of basic copper carbonate particles of this invention admixed (and partially coated with) the same quantity of tebuconazole.

The examples are merely indicative of the nature of the present invention, and should not be construed as limiting the scope of the invention, nor of the appended claims, in any manner. The invention is meant to be illustrated by these examples, but not limited to these examples.

TABLE 2

| | | 96 hr. | 240 hr. |
|---|---|---|---|
| | | ratio | ratio |
| Ex. | Description of Preservative System | to CCA | to CCA |
| A | 3% TEB and basic copper carbonate particles | 0.67:1 | 0.51:1 |
| C | 3% TEB and copper MEA carbonate | 5.2:1 | 3.85:1 |
| | (comparative) | | |
| D | 3% TEB and basic copper carbonate | 0.54:1 | 0.46:1 |
| | particles with sodium bicarbonate buffer | | |
| E | basic copper carbonate particles | 0.77:1 | 0.63:1 |
| F | 3% TEB and copper hydroxide with | 0.2:1 | 0.19:1 |
| | Zn and Mg particles | | |
| G | 5% TEB and copper hydroxide particles | 1.0:1 | 0.88:1 |
| | modified with phosphate coating | | |
| H | 3% TEB and tri-basic copper sulfate particles | 0.96:1 | 0.88:1 |
| I | 3% TEB and copper oxychloride particles | 1.4:1 | 1.17:1 |

What is claimed is:

1. A method for preserving wood comprising the steps of:
A) providing a slurry comprising
i. particles comprising a sparingly soluble copper salt particles, copper hydroxide particles, or both, wherein the weight average diameter d₅₀ of the particles in the slurry is between 0.1 microns and 0.7 microns and the d₉₈ of the particles in the slurry is less than about 1 micron,
ii. an effective amount of a dispersant, and
iii. a liquid carrier; and
B) injecting the slurry into wood.

2. The method of claim 1, wherein the dispersant comprises an anionic dispersant.

3. The method of claim 1, wherein the dispersant comprises a anionic dispersant and a non-ionic dispersant.

4. The method of claim 1, wherein less than 20% by weight of the sparingly soluble copper salt particles, copper hydroxide particles, or both, in the slurry is contained in particles having a diameter less than 20 nanometers.

5. The method of claim 1, wherein the slurry further comprises soluble complexes of copper with an amine.

6. The method of claim 1, wherein at least a portion of the sparingly soluble copper salt particles comprises basic copper carbonate, tri-basic copper sulfate, copper oxychloride, basic copper nitrate, basic copper borate, basic copper phosphate, or combinations thereof.

7. The method of claim 1, wherein at least a portion of the sparingly soluble copper salt particles comprises copper borate or copper silicate.

8. The method of claim 1, wherein the slurry comprises copper hydroxide particles.

9. The method of claim 8, wherein the copper hydroxide comprises an effective amount of magnesium substitutes for copper, such that the copper hydroxide is resistant to conversion to copper oxide.

10. The method of claim 8, wherein the copper hydroxide comprises an effective amount of zinc substituted for copper, such that the copper hydroxide is resistant to conversion to copper oxide.

11. The method of claim 8, wherein at least a portion of the particles comprise copper/magnesium/zinc hydroxide wherein there are between 6 parts and 20 parts total of magnesium and zinc per 100 parts copper.

12. The method of claim 8, wherein at least a portion of the particles comprise phosphate.

13. The method of claim 1, wherein the slurry further comprises at least one organic biocide, wherein at least a portion of the organic biocide is coated on the particles.

14. The method of claim 13, wherein at least a portion of the particles comprise an organic coating and an organic biocide disposed thereon.

15. The method of claim 1, wherein the d₅₀ of the copper-containing particles in the slurry is between about 0.15 microns and about 0.25 microns.

16. The method of claim 1, wherein the providing comprises wet milling particles comprising sparingly soluble copper salt particles, copper hydroxide particles, or both with a milling medium having a density equal to or greater than about 3.8 grams/cm³ and a diameter between about 0.3 mm and about 1.5 mm.

17. The method of claim 16, wherein the wet milling is performed in the presence of a dispersing agent.

18. A method for preserving wood comprising the steps of:
A) providing a slurry comprising:
particles comprising a sparingly soluble copper salt, copper hydroxide, or both, wherein at least 80% by weight of the particles has a diameter less than about 1 micron and at least about 50% by weight of the particles has a diameter greater than about 0.1 microns,
an effective amount of a dispersant, and
a liquid carrier; and
B) injecting the slurry into wood.

19. The method of claim 18, wherein the slurry further comprises soluble complexes of copper with an amine.

20. The method of claim 18, wherein at least a portion of the sparingly soluble copper salt particles comprises basic sparingly soluble copper salts.

21. The method of claim 18, wherein the slurry comprises copper hydroxide particles.

22. The method of claim 21, wherein the copper hydroxide comprises an effective amount of magnesium substituted for copper, such that the copper hydroxide is resistant to conversion to copper oxide.

23. The method of claim 21, wherein the copper hydroxide comprises an effective amount of zinc substituted for copper, such that the copper hydroxide is resistant to conversion to copper oxide.

24. The method of claim 21, wherein at least a portion of the particles comprise phosphate.

25. The method of claim 21, wherein the slurry further comprises at least one organic biocide, wherein at least a portion of the organic biocide is coated on the particles.

26. The method of claim 25, wherein at least a portion of the particles comprise an anionic dispersant and an organic biocide disposed on the surface thereof.

27. The method of claim 21, wherein the providing comprises wet milling particles comprising sparingly soluble copper salt particles, copper hydroxide particles, or both with a milling medium having a density equal to or greater than about 3.8 grams/cm³ and a diameter between about 0.3 mm and about 1.5 mm.

28. The method of claim 27, wherein the wet milling is performed in the presence of a dispersing agent.

29. The method of claim 21, further comprising the step of partially dissolving the particles by contacting the particles with a sufficient amount of an amine and anionic surface agents such that at least 5% by weight of the copper material is dissolved, prior to injecting the material into wood.

30. The method of claim 21, wherein the slurry further comprises hydroxyethylidene diphosphonic acid.

31. A method for preserving wood comprising the steps of:
providing a slurry comprising:
copper hydroxide particles, wherein the weight average diameter (d₅₀) of the particles is between about 0.15 microns and about 0.17 microns,
an effective amount of a dispersant, and
a liquid carrier; and
injecting the slurry into wood.

32. The method of claim 31, wherein the copper hydroxide comprises an effective amount of magnesium substituted for copper, such that the copper hydroxide is resistant to conversion to copper oxide.

33. The method of claim 31, wherein the copper hydroxide comprises an effective amount of zinc substituted for copper, such that the copper hydroxide is resistant to conversion to copper oxide.

34. The method of claim 31, wherein at least a portion of the particles comprise copper/magnesium/zinc hydroxide wherein there are between 6 parts and 20 parts total of magnesium and zinc per 100 parts copper.

35. The method of claim 31, wherein the slurry further comprises at least one organic biocide, wherein at least a portion of the organic biocide is coated on the particles.

36. The method of claim 31, wherein the particles comprise less than 40 ppm lead based on the weight of the particles.

37. The method of claim 31, wherein the providing comprises wet milling particles comprising sparingly soluble copper salt particles, copper hydroxide particles, or both with a milling medium having a density equal to or greater than about 3.8 grams/cm³ and a diameter between about 0.3 mm and about 1.5 mm.

38. The method of claim 31, wherein the wet milling is performed in the presence of a dispersing agent.

39. The method of claim 31, further comprising the step of partially dissolving the particles by contacting the particles with a sufficient amount of an amine and anionic surface agents such that at least 5% by weight of the copper material is dissolved.

40. The method of claim 31, wherein the providing comprises admixing a dry mix comprising the particles and a dispersing agent with water.

41. The method of claim 40, wherein the dry mix further comprises a granulating agent that is dispersible in water.
